(19) United States
(12) Patent Application Publication
(10) Pub. No.: US 2013/0335405 A1
(43) Pub. Date: Dec. 19, 2013

(54) VIRTUAL OBJECT GENERATION WITHIN A VIRTUAL ENVIRONMENT

(71) Applicants: Michael J. Scavezze, Bellevue, WA (US); Jonathan T. Steed, Redmond, WA (US); Ryan L. Hastings, Seattle, WA (US); Stephen G. Latta, Seattle, WA (US); Daniel J. McCulloch, Kirkland, WA (US)

(72) Inventors: Michael J. Scavezze, Bellevue, WA (US); Jonathan T. Steed, Redmond, WA (US); Ryan L. Hastings, Seattle, WA (US); Stephen G. Latta, Seattle, WA (US); Daniel J. McCulloch, Kirkland, WA (US)

(21) Appl. No.: 13/525,700

(22) Filed: Jun. 18, 2012

(51) Int. Cl. G06T 15/00

(52) U.S. Cl. 345/419

(57) ABSTRACT

A system and method are disclosed for building and experiencing three-dimensional virtual objects from within a virtual environment in which they will be viewed upon completion. A virtual object may be created, edited and animated using a natural user interface while the object is displayed to the user in a three-dimensional virtual environment.

### BACKGROUND

Mixed reality is a technology that allows virtual imagery to be mixed with a real-world physical environment. A see-through, head mounted, mixed reality display device may be worn by a user to view the mixed imagery of real objects and virtual objects displayed in the user's field of view. Content generation software applications are known allowing creators to generate three-dimensional virtual objects, which objects may then be used in a mixed reality environment. Users of such software applications fashion and edit virtual objects on a computer by interacting with traditional input devices such as a mouse and keyboard, while viewing objects being created and edited on a two-dimensional monitor.

There are a few drawbacks to this method of virtual object creation. Creating virtual objects for a three-dimensional environment on a two-dimensional monitor results in some guesswork by the content creator as to how various aspects of the virtual object will translate when displayed in the virtual environment. Often aspects of a virtual object appear to be visible on the two-dimensional monitor, only to be difficult to see when translated into the three-dimensional virtual environment. Moreover, creating virtual objects on a two-dimensional monitor makes it difficult to get a sense of scale and perspective for the virtual object when placed with other virtual objects in the virtual environment.

### SUMMARY

Embodiments of the present technology relate to a system and method for building and experiencing three-dimensional virtual objects from within a virtual environment in which they will be viewed upon completion. A system for creating virtual objects within a virtual environment in general includes a see-through, head mounted display device coupled to one or more processing units. The processing units in cooperation with the head mounted display unit(s) are able to display one or more virtual objects, also referred to as holographic objects, to the user in the virtual environment as they are being created. Allowing a user to build virtual objects in a virtual environment in which they will be viewed simplifies the creation process and improves the ability of the user to fit the scale and perspective of virtual objects together in the environment.

In an example, the present technology relates to a system for presenting a virtual environment to one or more users, the virtual environment being coextensive with a real-world space, the system comprising: a display device for a user, the display device including a display unit for displaying one or more virtual objects in the virtual environment to the user of the display device; and a computing system operatively coupled to the display device, the computing system generating the one or more virtual objects in the virtual environment based on input from the user, the one or more virtual objects displayed via the display device as the one or more virtual objects are generated in the virtual environment.

In another example, the present technology relates to A method for generating virtual objects in a virtual environment, the virtual environment coextensive with a real-world space, the method comprising: (a) altering a virtual object in the virtual environment in response to interaction with the virtual object; and (b) saving the alteration to the virtual object made in said step (a).

In a further example, the present technology relates to a method of generating one or more virtual objects in a virtual environment, the virtual environment coextensive with a real-world space, the method comprising: (a) receiving a selection of a virtual object to add to the virtual environment; (b) receiving an indication of a position within the virtual environment where the virtual object is to be added; (c) adding the virtual object selected in said step (a) to the virtual environment at the position indicated in said step (b); (d) displaying the virtual object via a display device from different perspectives as a position of the display device changes within the virtual environment; and (e) altering a shape of the virtual object in response physical gestures performed at one or more positions in three-dimensional space occupied by the virtual object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of example components of one embodiment of a system for presenting a virtual environment to one or more users.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the components of a hub computing system used with a head mounted display unit.

FIG. 7 is a block diagram of one embodiment of a computing system that can be used to implement the hub computing system described herein.

FIG. 8 is an illustration of an example of a virtual environment with creators generating and editing virtual objects in a scene.

FIG. 9 is a flowchart showing the operation and collaboration of the hub computing system, one or more processing units and one or more head mounted display units of the present system.

FIGS. 10-15A are more detailed flowcharts of examples of various steps shown in the flowchart of FIG. 9.

FIG. 16 is an illustration of a creator manually creating a virtual object in a virtual environment.

FIG. 17 is an illustration of a virtual object being constructed in a virtual environment from multiple generic starting shapes.

FIG. 18 is an illustration of a creator animating a virtual object in a virtual environment.

FIG. 19 is an illustration of a creator interacting with a content-generation software application displayed to the creator within a virtual environment.

### DETAILED DESCRIPTION

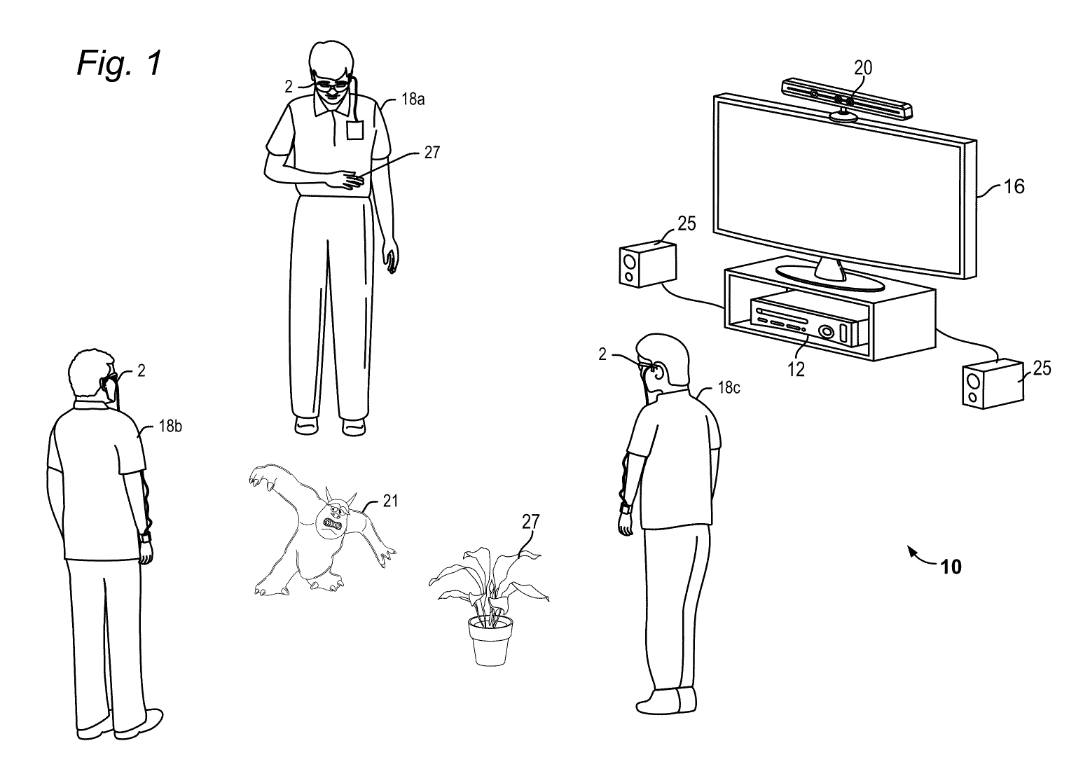

Embodiments of the present technology will now be described with reference to FIGS. 1-19, which in general relate to a system and method for building and experiencing three-dimensional virtual objects from within a virtual environment in which they will be viewed upon completion. The system for implementing the virtual environment includes a mobile display device communicating with a hub computing system. The mobile display device may include a mobile processing unit coupled to a head mounted display device (or other suitable apparatus) having a display element.

Each user wears a head mounted display device including a display element. The display element is to a degree transparent so that a user can look through the display element at real-world objects within the user's field of view (FOV). The display element also provides the ability to project virtual images into the FOV of the user such that the virtual images may also appear alongside the real-world objects. The system automatically tracks where the user is looking so that the system can determine where to insert the virtual image in the FOV of the user. Once the system knows where to project the virtual image, the image is projected using the display element.

In embodiments, the hub computing system and one or more of the processing units may cooperate to build a model of the environment including the x, y, z Cartesian positions of all users, real-world objects and virtual three-dimensional objects in the room or other environment. The positions of each head mounted display device worn by the users in the environment may be calibrated to the model of the environment and to each other. This allows the system to determine each user's line of sight and FOV of the environment. Thus, a virtual image may be displayed to each user, but the system determines the display of the virtual image from each user's perspective, adjusting the virtual image for parallax and any occlusions from or by other objects in the environment. The model of the environment, referred to herein as a scene map, as well as all tracking of each user's FOV and objects in the environment may be generated by the hub computing system and processing unit working in tandem or individually.

A virtual environment provided by present system may be coextensive with a real-world space. In other words, the virtual environment may be laid over and share the same area as a real-world space. A user moving around a real-world space may also move around in the coextensive virtual environment, and view virtual and/or real objects from different perspectives and vantage points. One type of virtual environment is a mixed reality environment, where the virtual environment includes both virtual objects and real-world objects. Another type of virtual environment includes only virtual objects.

The virtual environment may fit within the confines of a room or other real-world space. Alternatively, the virtual environment may be larger than the confines of the real-world physical space. Virtual environments may be completely created by one or more users. Alternatively, portions of the virtual environment may be downloaded, for example from a software application running on the hub computing system.

As explained below, aspects of the present system allow users to generate virtual objects that are displayed three-dimensionally to the user as they are being created. The hub computing system may execute a content-generation software application, which constructs virtual objects within the virtual environment in accordance with input received from the user. As utilized herein, the term “user” may refer to a content creator using a mixed reality system to create, edit and animate virtual objects. The term “end user” may refer to those who thereafter experience the completed virtual objects using a mixed reality system.

The term “virtual object” as used herein includes objects that are partially or fully completed. For example, a user may choose to create a virtual object in the form of an animal. During its construction, a part of the animal may be displayed, or a generalized frame may be displayed, that will be further shaped by the user into an animal. The displayed parts and the generalized frame are both virtual objects as used herein. A virtual object may be described herein as a “completed virtual object” once work on the virtual object is finished.

A user may choose to interact with the content-generation software application running on the hub computing system, as well as interact with one or more of the virtual objects appearing within the user's FOV. When a user is generating virtual objects for a scene, or after a virtual object is completed, the term “interact” encompasses both physical and verbal gestures to create, edit and/or animate the virtual object. Physical gestures include a user performing a predefined gesture using his or her fingers, hands and/or other body parts recognized by the mixed reality system as a user request for the system to perform a predefined action. Such predefined gestures may include, but are not limited to, pointing at, grabbing, pushing and shaping virtual objects. Physical interaction may further include contact by the user with a virtual object. For example, a user pushing or bumping into a virtual object (i.e., a user moving to a location where a virtual object is positioned in three-dimensional space) may be an interaction causing the virtual object to move. As a further example, a user can interact with a virtual button by pushing it.

A user may also physically interact with a virtual object with his or her eyes. In some instances, eye gaze data identifies where a user is focusing in the FOV, and can thus identify that a user is looking at a particular virtual object. Sustained eye gaze, or a blink or blink sequence, may thus be a physical interaction whereby a user selects one or more virtual objects.

A user may alternatively or additionally interact with virtual objects using verbal gestures, such as for example a spoken word or phrase recognized by the mixed reality system as a user request for the system to perform a predefined action. Verbal gestures may be used in conjunction with physical gestures to interact with one or more virtual objects in the virtual environment.

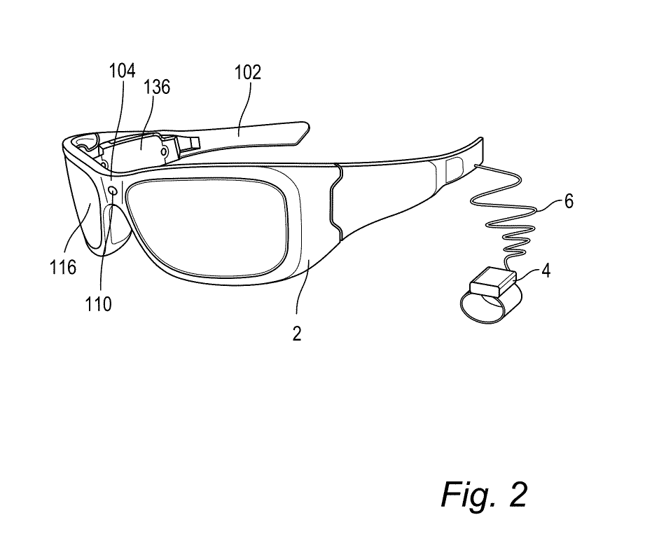

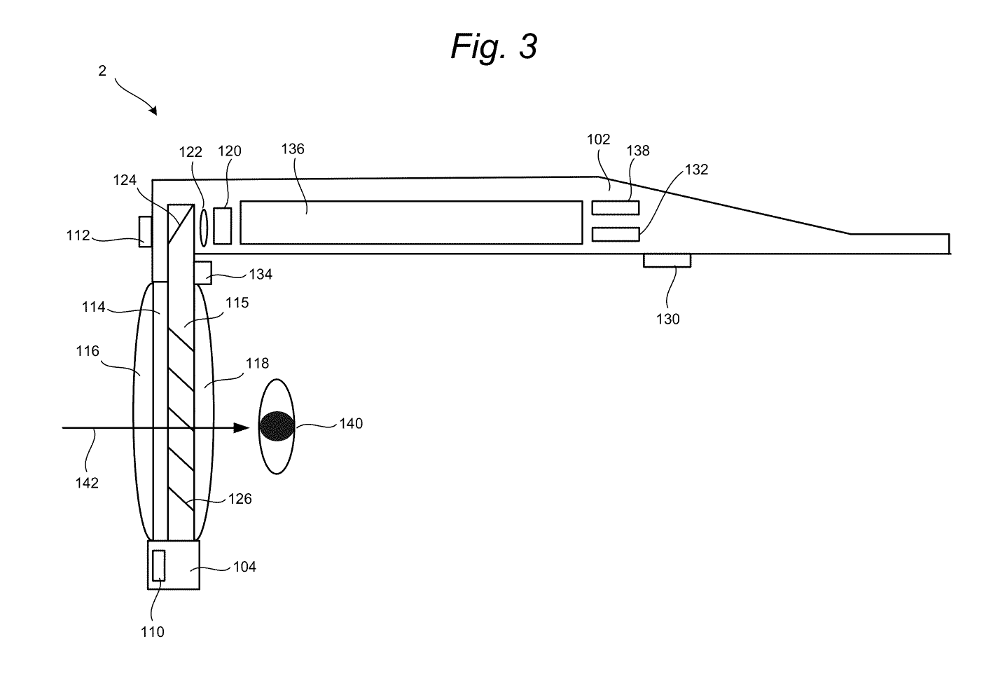

FIG. 1 illustrates a system 10 for providing a mixed reality experience by fusing virtual content 21 (completed virtual content in this example) with real content 27 within a user's FOV. FIG. 1 shows a number of users 18a, 18b and 18c each wearing a head mounted display device 2. As seen in FIGS. 2 and 3, each head mounted display device 2 is in communication with its own processing unit 4 via wire 6. In other embodiments, head mounted display device 2 communicates with processing unit 4 via wireless communication. Head mounted display device 2, which in one embodiment is in the shape of glasses, is worn on the head of a user so that the user can see through a display and thereby have an actual direct view of the space in front of the user. The use of the term “actual direct view” refers to the ability to see the real-world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

In one embodiment, processing unit 4 is a small, portable device for example worn on the user's wrist or stored within a user's pocket. The processing unit may for example be the size and form factor of a cellular telephone, though it may be other shapes and sizes in further examples. The processing unit 4 may include much of the computing power used to operate head mounted display device 2. In embodiments, the processing unit 4 communicates wirelessly (e.g., WiFi, Bluetooth, infra-red, or other wireless communication means) to one or more hub computing systems 12. As explained hereinafter, hub computing system 12 (also referred to as hub 12) may be omitted in further embodiments to provide a completely mobile mixed reality experience using only the head mounted display devices 2 and processing units 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. In one embodiment, hub computing system 12 may include a processor such as a standardized processor, a specialized processor, a microprocessor, or the like that may execute instructions stored on a processor readable storage device for performing the processes described herein.

Hub computing system 12 further includes a capture device 20 for capturing image data from portions of a scene within its FOV. As used herein, a scene is the environment in which the users move around, which environment is captured within the FOV of the capture device 20 and/or the FOV of each head mounted display device 2. FIG. 1 shows a single capture device 20, but there may be multiple capture devices in further embodiments which cooperate to collectively capture image data from a scene within the composite FOVs of the multiple capture devices 20. Capture device 20 may include one or more cameras that visually monitor the one or more users 18a, 18b, 18c and the surrounding space such that gestures and/or movements performed by the one or more users, as well as the structure of the surrounding space, may be captured, analyzed, and tracked to perform one or more controls or actions within the application and/or animate an avatar or on-screen character.

Hub computing system 12 may be connected to an audiovisual device 16 such as a television, a monitor, a high-definition television (HDTV), or the like that may provide game or application visuals. For example, hub computing system 12 may include a video adapter such as a graphics card and/or an audio adapter such as a sound card that may provide audiovisual signals associated with the game application, non-game application, etc. The audiovisual device 16 may receive the audiovisual signals from hub computing system 12 and may then output the game or application visuals and/or audio associated with the audiovisual signals. According to one embodiment, the audiovisual device 16 may be connected to hub computing system 12 via, for example, an S-Video cable, a coaxial cable, an HDMI cable, a DVI cable, a VGA cable, a component video cable, RCA cables, etc. In one example, audiovisual device 16 includes internal speakers. In other embodiments, audiovisual device 16 and hub computing system 12 may be connected to external speakers 25.

Hub computing system 12, with capture device 20, may be used to recognize, analyze, and/or track human (and other types of) targets. For example, one or more of the users 18a, 18b and 18c wearing head mounted display devices 2 may be tracked using the capture device 20 such that the gestures and/or movements of the users may be captured to animate one or more avatars or on-screen characters. The movements may also or alternatively be interpreted as controls that may be used to affect the application being executed by hub computing system 12. The hub computing system 12, together with the head mounted display devices 2 and processing units 4, may also together provide a mixed reality experience where one or more virtual images, such as completed virtual object 21 in FIG. 1, may be mixed together with real-world objects in a scene. FIG. 1 illustrates examples of a plant 27 or a user's hand 27 as real-world objects appearing within the user's FOV.

FIGS. 2 and 3 show perspective and side views of the head mounted display device 2. FIG. 3 shows only the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. In some embodiments, head mounted display device 2 will include only one see-through lens or no see-through lenses. In another alternative, a prescription lens can go inside light-guide optical element 115. Opacity filter 114 filters out natural light (either on a per pixel basis or uniformly) to enhance the contrast of the virtual imagery. Light-guide optical element 115 channels artificial light to the eye. More details of opacity filter 114 and light-guide optical element 115 are provided below.

Mounted to or inside temple 102 is an image source, which (in one embodiment) includes microdisplay 120 for projecting a virtual image and lens 122 for directing images from microdisplay 120 into light-guide optical element 115. In one embodiment, lens 122 is a collimating lens.

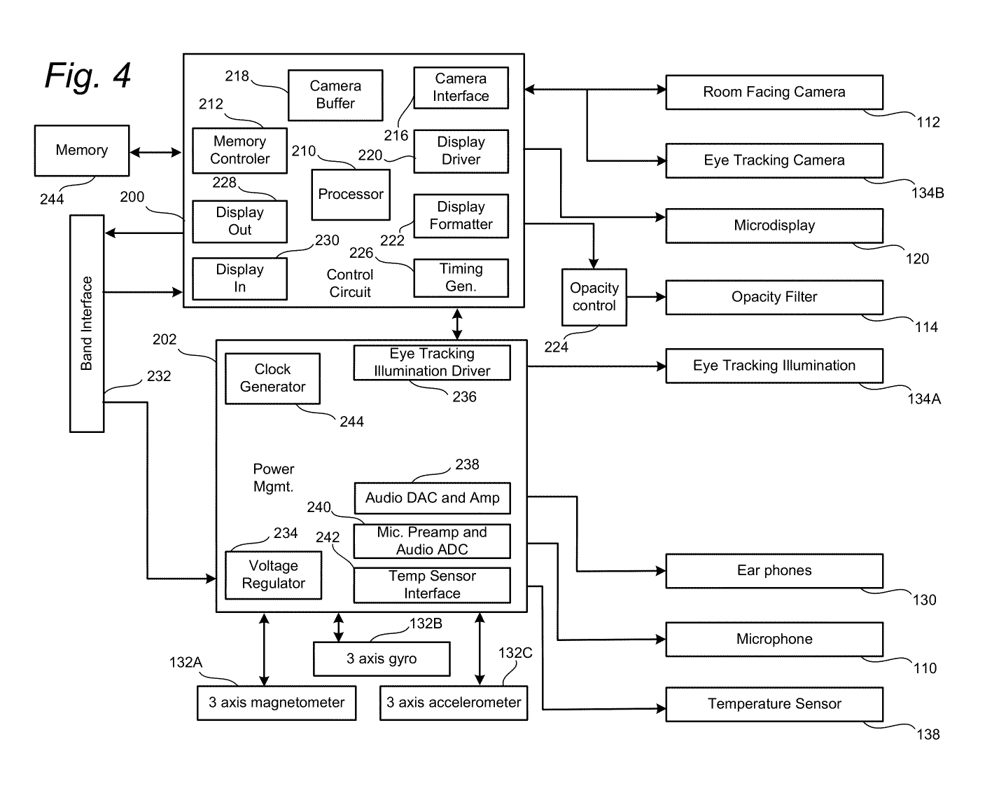

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light-guide optical element can be found in United States Patent Publication No. 2008/0285140, entitled “Substrate-Guided Optical Devices,” published on Nov. 20, 2008, incorporated herein by reference in its entirety. In one embodiment, each eye will have its own light-guide optical element 115. When the head mounted display device 2 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an example of opacity filter 114 are provided in U.S. Patent Publication No. 2012/0068913 to Bar-Zeev et al., entitled “Opacity Filter For See-Through Mounted Display,” filed on Sep. 21, 2010, incorporated herein by reference in its entirety. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel.

A mask of alpha values can be used from a rendering pipeline, after z-buffering with proxies for real-world objects. When the system renders a scene for the augmented reality display, it takes note of which real-world objects are in front of which virtual objects as explained below. If a virtual object is in front of a real-world object, then the opacity may be on for the coverage area of the virtual object. If the virtual object is (virtually) behind a real-world object, then the opacity may be off, as well as any color for that pixel, so the user will only see the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are the most desirable for this use. Moreover, the opacity filter can be rendered in color, such as with a color LCD or with other displays such as organic LEDs.

Head mounted display device 2 also includes a system for tracking the position of the user's eyes. As will be explained below, the system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 2 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008, incorporated herein by reference. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but only one infrared CCD on the side of the lens of head mounted display device 2. The CCD will use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 only shows half of the head mounted display device 2. A full head mounted display device may include another set of see-through lenses, another opacity filter, another light-guide optical element, another microdisplay 120, another lens 122, room-facing camera, eye tracking assembly, micro display, earphones, and temperature sensor.

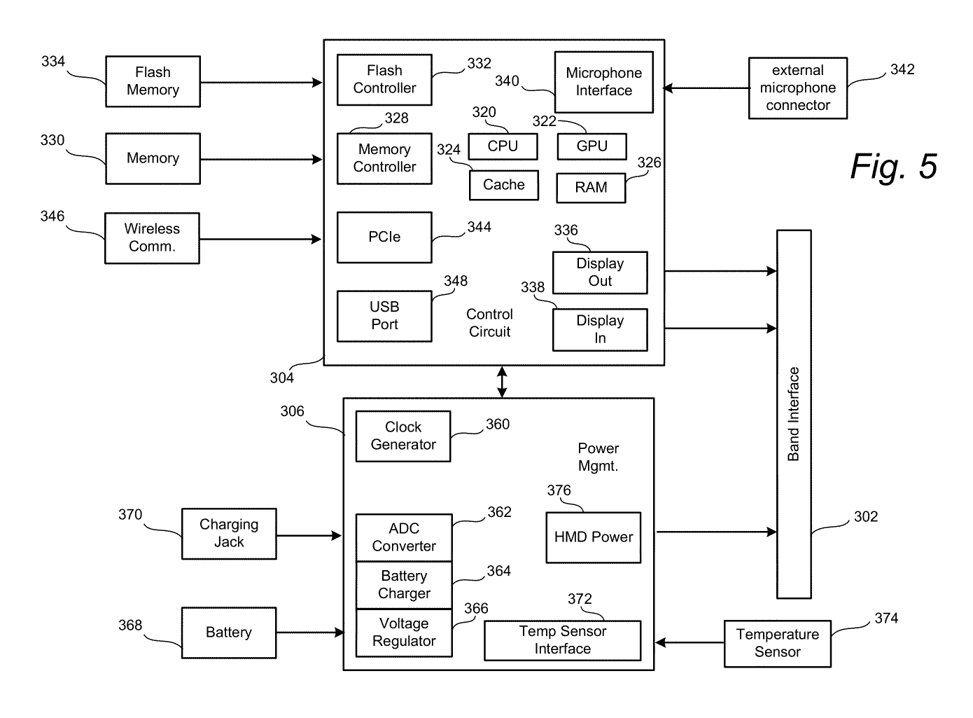

FIG. 4 is a block diagram depicting the various components of head mounted display device 2. FIG. 5 is a block diagram describing the various components of processing unit 4. Head mounted display device 2, the components of which are depicted in FIG. 4, is used to provide a mixed reality experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4, the components of which are depicted in FIG. 4, will receive the sensory information from head mounted display device 2 and will exchange information and data with the hub computing system 12 (FIG. 1). Based on that exchange of information and data, processing unit 4 will determine where and when to provide a virtual image to the user and send instructions accordingly to the head mounted display device of FIG. 4.

Some of the components of FIG. 4 (e.g., room-facing camera 112, eye tracking camera 134B, microdisplay 120, opacity filter 114, eye tracking illumination 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, the components of control circuit 200 are in communication with each other via dedicated lines or one or more buses. In another embodiment, the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to hub computing system 12 in order to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

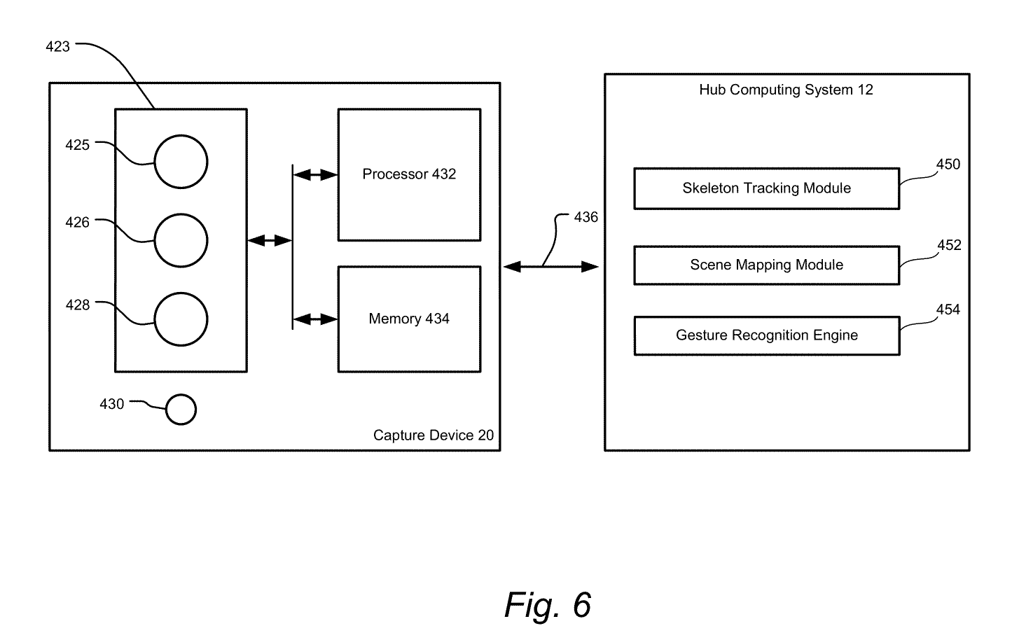

FIG. 6 illustrates an example embodiment of hub computing system 12 with a capture device 20. According to an example embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 6, capture device 20 may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 20 may emit an infrared light onto the scene and may then use sensors (in some embodiments, including sensors not shown) to detect the backscattered light from the surface of one or more targets and objects in the scene using, for example, the 3-D camera 426 and/or the RGB camera 428. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, capture device 20 may use a structured light to capture depth information. In such an analysis, patterned light (i.e., light displayed as a known pattern such as a grid pattern, a stripe pattern, or different pattern) may be projected onto the scene via, for example, the IR light component 425. Upon striking the surface of one or more targets or objects in the scene, the pattern may become deformed in response. Such a deformation of the pattern may be captured by, for example, the 3-D camera 426 and/or the RGB camera 428 (and/or other sensor) and may then be analyzed to determine a physical distance from the capture device to a particular location on the targets or objects. In some implementations, the IR light component 425 is displaced from the cameras 426 and 428 so triangulation can be used to determined distance from cameras 426 and 428. In some implementations, the capture device 20 will include a dedicated IR sensor to sense the IR light, or a sensor with an IR filter.

According to another embodiment, one or more capture devices 20 may include two or more physically separated cameras that may view a scene from different angles to obtain visual stereo data that may be resolved to generate depth information. Other types of depth image sensors can also be used to create a depth image.

The capture device 20 may further include a microphone 430, which includes a transducer or sensor that may receive and convert sound into an electrical signal. Microphone 430 may be used to receive audio signals that may also be provided to hub computing system 12.

In an example embodiment, the capture device 20 may further include a processor 432 that may be in communication with the camera component 423. Processor 432 may include a standardized processor, a specialized processor, a microprocessor, or the like that may execute instructions including, for example, instructions for receiving a depth image, generating the appropriate data format (e.g., frame) and transmitting the data to hub computing system 12.

Capture device 20 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 6, in one embodiment, memory 434 may be a separate component in communication with the camera component 423 and processor 432. According to another embodiment, the memory 434 may be integrated into processor 432 and/or the camera component 423.

Capture device 20 is in communication with hub computing system 12 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, hub computing system 12 may provide a clock to capture device 20 that may be used to determine when to capture, for example, a scene via the communication link 436. Additionally, the capture device 20 provides the depth information and visual (e.g., RGB) images captured by, for example, the 3-D camera 426 and/or the RGB camera 428 to hub computing system 12 via the communication link 436. In one embodiment, the depth images and visual images are transmitted at 30 frames per second; however, other frame rates can be used. Hub computing system 12 may then create and use a model, depth information, and captured images to, for example, control an application such as a game or word processor and/or animate an avatar or on-screen character.

Hub computing system 12 includes a skeletal tracking module 450. Module 450 uses the depth images obtained in each frame from capture device 20, and possibly from cameras on the one or more head mounted display devices 2, to develop a representative model of each user 18a, 18b, 18c (or others) within the FOV of capture device 20 as each user moves around in the scene. This representative model may be a skeletal model described below. Hub computing system 12 may further include a scene mapping module 452. Scene mapping module 452 uses depth and possibly RGB image data obtained from capture device 20, and possibly from cameras on the one or more head mounted display devices 2, to develop a map or model of the scene in which the users 18a, 18b, 18c exist. The scene map may further include the positions of the users obtained from the skeletal tracking module 450. The hub computing system may further include a gesture recognition engine 454 for receiving skeletal model data for one or more users in the scene and determining whether the user is performing a predefined gesture or application-control movement affecting an application running on hub computing system 12.

The skeletal tracking module 450 and scene mapping module 452 are explained in greater detail below. More information about gesture recognition engine 454 can be found in U.S. patent application Ser. No. 12/422,661, entitled “Gesture Recognizer System Architecture,” filed on Apr. 13, 2009, incorporated herein by reference in its entirety. Additional information about recognizing gestures can also be found in U.S. patent application Ser. No. 12/391,150, entitled “Standard Gestures,” filed on Feb. 23, 2009; and U.S. patent application Ser. No. 12/474,655, entitled “Gesture Tool” filed on May 29, 2009, both of which are incorporated herein by reference in their entirety.

Capture device 20 provides RGB images (or visual images in other formats or color spaces) and depth images to hub computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as the distance of an object in the captured scene from the capture device. Hub computing system 12 will use the RGB images and depth images to develop a skeletal model of a user and to track a user's or other object's movements. There are many methods that can be used to model and track the skeleton of a person with depth images. One suitable example of tracking a skeleton using depth image is provided in U.S. patent application Ser. No. 12/603,437, entitled “Pose Tracking Pipeline” filed on Oct. 21, 2009, (hereinafter referred to as the '437 Application), incorporated herein by reference in its entirety.

The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a group of joints and connections between the joints. Other methods for user modeling and tracking can also be used. Suitable tracking technologies are also disclosed in the following four U.S. patent applications, all of which are incorporated herein by reference in their entirety: U.S. patent application Ser. No. 12/475,308, entitled “Device for Identifying and Tracking Multiple Humans Over Time,” filed on May 29, 2009; U.S. patent application Ser. No. 12/696,282, entitled “Visual Based Identity Tracking,” filed on Jan. 29, 2010; U.S. patent application Ser. No. 12/641,788, entitled “Motion Detection Using Depth Images,” filed on Dec. 18, 2009; and U.S. patent application Ser. No. 12/575,388, entitled “Human Tracking System,” filed on Oct. 7, 2009.

The above-described hub computing system 12, together with the head mounted display device 2 and processing unit 4, are able to insert a virtual three-dimensional object into the FOV of one or more users so that the virtual three-dimensional object augments and/or replaces the view of the real world. In one embodiment, head mounted display device 2, processing unit 4 and hub computing system 12 work together as each of the devices includes a subset of sensors that are used to obtain the data to determine where, when and how to insert the virtual three-dimensional object. In one embodiment, the calculations that determine where, when and how to insert a virtual three-dimensional object are performed by the hub computing system 12 and processing unit 4 working in tandem with each other. However, in further embodiments, all calculations may be performed by the hub computing system 12 working alone or the processing unit(s) 4 working alone. In other embodiments, at least some of the calculations can be performed by a head mounted display device 2.

In one example embodiment, hub computing system 12 and processing units 4 work together to create the scene map or model of the environment that the one or more users are in and track various moving objects in that environment. In addition, hub computing system 12 and/or processing unit 4 track the FOV of a head mounted display device 2 worn by a user 18a, 18b, 18c by tracking the position and orientation of the head mounted display device 2. Sensor information obtained by head mounted display device 2 is transmitted to processing unit 4. In one example, that information is transmitted to the hub computing system 12 which updates the scene model and transmits it back to the processing unit. The processing unit 4 then uses additional sensor information it receives from head mounted display device 2 to refine the FOV of the user and provide instructions to head mounted display device 2 on where, when and how to insert the virtual three-dimensional object. Based on sensor information from cameras in the capture device 20 and head mounted display device(s) 2, the scene model and the tracking information may be periodically updated between hub computing system 12 and processing unit 4 in a closed loop feedback system as explained below.

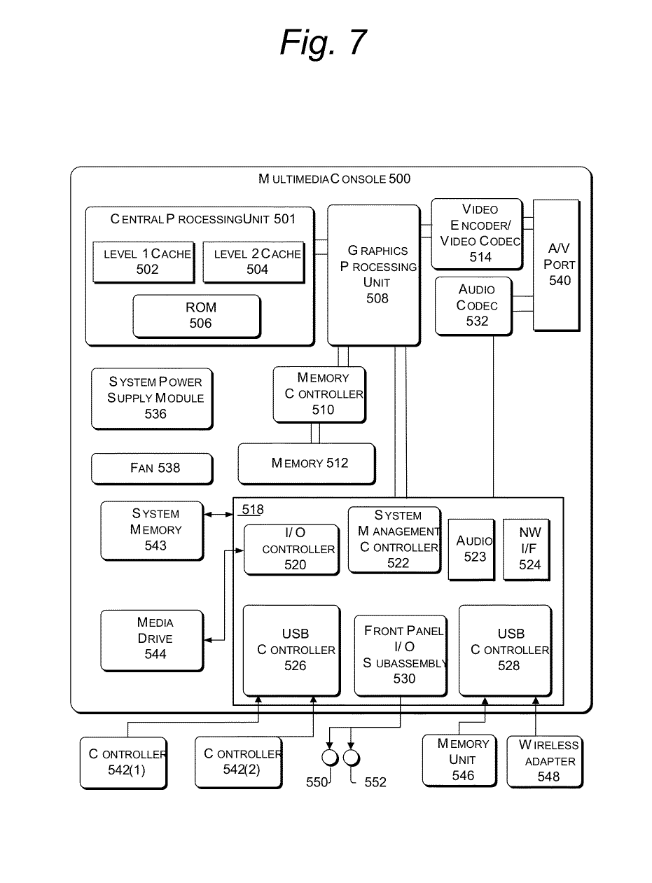

FIG. 7 illustrates an example embodiment of a computing system that may be used to implement hub computing system 12. As shown in FIG. 7, the multimedia console 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the AN port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that changing frequency and causing a TV resync may be reduced or eliminated.

After multimedia console 500 boots and system resources are reserved, concurrent system applications execute to provide system functionalities. The system functionalities are encapsulated in a group of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application has audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 20 may define additional input devices for the console 500 via USB controller 526 or other interface. In other embodiments, hub computing system 12 can be implemented using other hardware architectures. No one hardware architecture is required.

Each of the head mounted display devices 2 and processing units 4 (collectively referred to at times as the mobile display device) shown in FIG. 1 are in communication with one hub computing system 12 (also referred to as the hub 12). There may be one or two or more mobile display devices in communication with the hub 12 in further embodiments. Each of the mobile display devices may communicate with the hub using wireless communication, as described above. In such an embodiment, it is contemplated that much of the information that is useful to the mobile display devices will be computed and stored at the hub and transmitted to each of the mobile display devices. For example, the hub will generate the model of the environment and provide that model to all of the mobile display devices in communication with the hub. Additionally, the hub can track the location and orientation of the mobile display devices and of the moving objects in the room, and then transfer that information to each of the mobile display devices.

In another embodiment, a system could include multiple hubs 12, with each hub including one or more mobile display devices. The hubs can communicate with each other directly or via the Internet (or other networks). Such an embodiment is disclosed in U.S. patent application Ser. No. 12/905,952 to Flaks et al., entitled “Fusing Virtual Content Into Real Content,” filed Oct. 15, 2010, which application is incorporated by reference herein in its entirety.

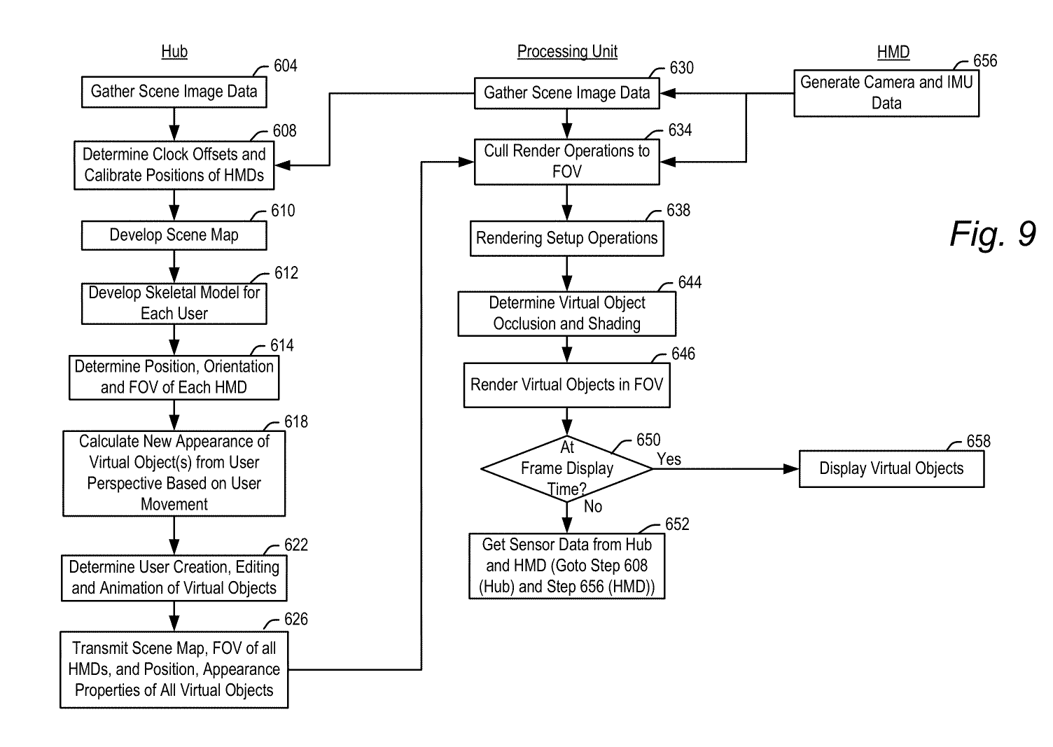

Moreover, in further embodiments, the hub 12 may be omitted altogether. One benefit of such an embodiment is that the mixed reality experience of the present system becomes completely mobile, and may be used in both indoor or outdoor settings. In such an embodiment, all functions performed by the hub 12 in the description that follows may alternatively be performed by one of the processing units 4, some of the processing units 4 working in tandem, or all of the processing units 4 working in tandem. In such an embodiment, the respective mobile display devices 580 perform all functions of system 10, including generating and updating state data, a scene map, each user's view of the scene map, all texture and rendering information, video and audio data, and other information to perform the operations described herein. The embodiments described below with respect to the flowchart of FIG. 9 include a hub 12. However, in each such embodiment, one or more of the processing units 4 may alternatively perform all described functions of the hub 12.

Using the components described above, users may construct virtual objects directly within a virtual environment, which objects may be viewed by users through their head mounted display devices 2 as they are being constructed. As noted in the Background section, conventional software applications generate virtual objects on a computer and monitor, and then translate them into a three-dimensional virtual environment. In accordance with aspects of the present technology, virtual objects may be created within a virtual environment, and may be displayed in the virtual environment as they are being created. A content-generation software application may be run on the hub computing system 12. As explained below, a user may provide commands and interact with the content-generation software application via the natural user interface described above so as to create virtual objects. The user may view the virtual object as they are being created in the virtual environment via the user's head mounted display 2. A virtual object may be created and edited by a user over time. Thus, the virtual object may be displayed each frame, in its state of progress, as the user forms the virtual object into a completed virtual object.

The virtual environment provided by system 10 facilitates creation of virtual objects in at least two ways. First, virtual objects may be created in a virtual environment using a natural user interface which is more user-friendly and intuitive that a keyboard, input device and monitor. A user may for example generate objects which are shaped with his own hands (as if creating or sculpting them from nothing), as well as from other gestures. This is a more natural, intuitive interface for creating objects than a keyboard, input device and monitor. Moreover, a user may use real-world objects, or the user himself, which may be captured by the cameras of the present system to generate and/or animate virtual object replicas in the virtual environment.

In addition to the ease afforded by the natural user interface, displaying a virtual object within the virtual environment as they are being created provides several benefits with regard to the appearance of the virtual object. Instead of creating it on a monitor and guessing how it will look when transferred into a virtual environment, the user may create the object directly into the environment. A user may move around the three-dimensional virtual object as it is being created in the environment so that the virtual object has a natural looking appearance within the environment once created. Additionally, it may be created in a proper size and position relative to other objects (virtual or real) within the environment. Each of these concepts is explained in greater detail below.

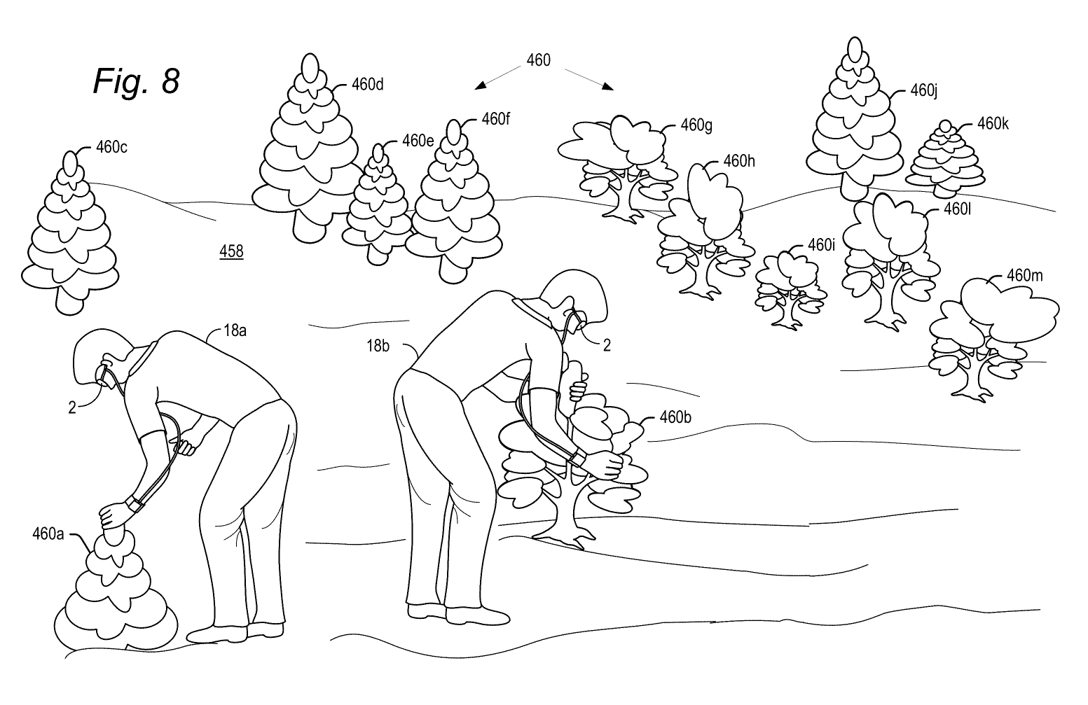

An example of users constructing virtual objects for a scene in a virtual environment is shown in FIG. 8, which shows the users immersed in the virtual environment 458 (the view shown in FIG. 8 would be seen for example through a head mounted display device 2). In the example shown, users 18a and 18b are collaborating to build a virtual forest including a number of virtual objects 460 in the form of virtual trees 460a-460m. The virtual forest of FIG. 8 is by way of example only, and it is understood that any type of virtual scene, including any type of virtual object, can be created using the present technology. In the example of FIG. 8, user 18a is creating a virtual object 460a. User 18b is editing a virtual object 460b. Further detail for creating and editing virtual objects is provided below.

FIG. 9 is high level flowchart of the operation and interactivity of the hub computing system 12, the processing unit 4 and head mounted display device 2 during a discrete time period such as the time it takes to generate, render and display a single frame of image data to each user. In embodiments, data may be refreshed at a rate of 60 Hz, though it may be refreshed more often or less often in further embodiments.

In general, the system generates a scene map having x, y, z coordinates of the environment and objects in the environment such as users, real-world objects and virtual objects. As noted above, one or more virtual objects 460 may be created, and displayed during creation, in the environment for example by one or more users interacting with a content-generation application running on hub computing system 12. The system also tracks the FOV of each user. While all users may possibly be viewing the same aspects of the scene, they are viewing them from different perspectives. Thus, the system generates each person's FOV of the scene to adjust for different viewing perspectives, parallax and occlusion of virtual or real-world objects, which may again be different for each user.

For a given frame of image data, a user's view may include one or more real and/or virtual objects. As a user turns his head, for example left to right or up and down, the relative position of real-world objects in the user's FOV inherently moves within the user's FOV. For example, plant 27 in FIG. 1 may appear on the right side of a user's FOV at first. But if the user then turns his head toward the right, the plant 27 may eventually end up on the left side of the user's FOV.

However, the display of virtual objects to a user as the user moves his head is a more difficult problem. In an example where a user is looking at a virtual object in his FOV, if the user moves his head left to move the FOV left, the display of the virtual object may be shifted to the right by an amount of the user's FOV shift, so that the net effect is that the virtual object remains stationary within the FOV.

In steps 604 and 630, hub 12 and processing unit 4 gather data from the scene. For the hub 12, this may be image and audio data sensed by the depth camera 426, RGB camera 428 and microphone 430 of capture device 20. For the processing unit 4, this may be image data sensed in step 656 by the head mounted display device 2, and in particular, by the cameras 112, the eye tracking assemblies 134 and the IMU 132. The data gathered by the head mounted display device 2 is sent to the processing unit 4 in step 656. The processing unit 4 processes this data, as well as sending it to the hub 12 in step 630.

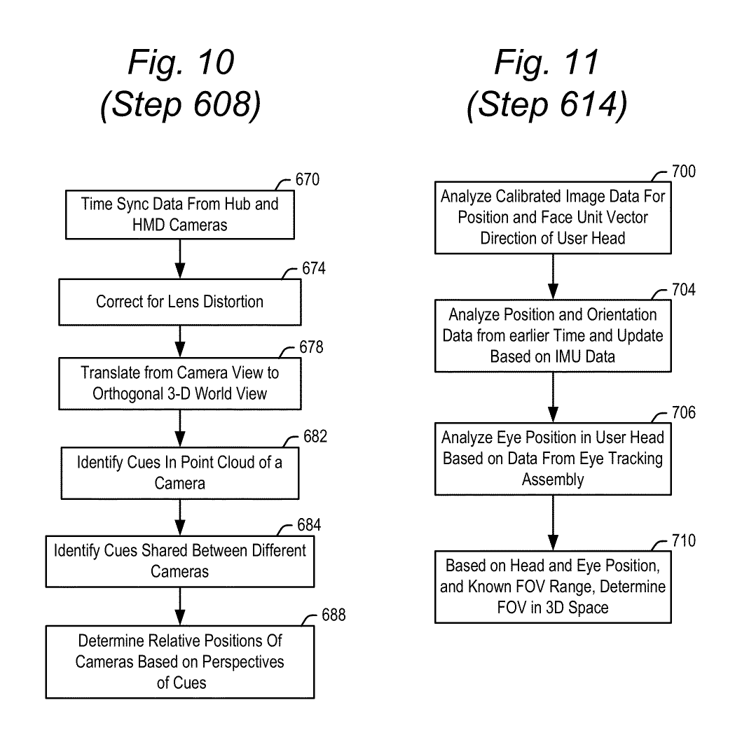

In step 608, the hub 12 performs various setup operations that allow the hub 12 to coordinate the image data of its capture device 20 and the one or more processing units 4. In particular, even if the position of the capture device 20 is known with respect to a scene (which it may not be), the cameras on the head mounted display devices 2 are moving around in the scene. Therefore, in embodiments, the positions and time capture of each of the imaging cameras may be calibrated to the scene, each other and the hub 12. Further details of step 608 are now described with reference to the flowchart of FIG. 10.

One operation of step 608 includes determining clock offsets of the various imaging devices in the system 10 in a step 670. In particular, in order to coordinate the image data from each of the cameras in the system, it may be confirmed that the image data being coordinated is from the same time. Details relating to determining clock offsets and synching of image data are disclosed in U.S. patent application Ser. No. 12/772,802, entitled “Heterogeneous Image Sensor Synchronization,” filed May 3, 2010, and U.S. patent application Ser. No. 12/792,961, entitled “Synthesis Of Information From Multiple Audiovisual Sources,” filed Jun. 3, 2010, which applications are incorporated herein by reference in their entirety. In general, the image data from capture device 20 and the image data coming in from the one or more processing units 4 are time stamped off a single master clock in hub 12. Using the time stamps for all such data for a given frame, as well as the known resolution for each of the cameras, the hub 12 determines the time offsets for each of the imaging cameras in the system. From this, the hub 12 may determine the differences between, and an adjustment to, the images received from each camera.

The hub 12 may select a reference time stamp from one of the cameras' received frame. The hub 12 may then add time to or subtract time from the received image data from all other cameras to synch to the reference time stamp. It is appreciated that a variety of other operations may be used for determining time offsets and/or synchronizing the different cameras together for the calibration process. The determination of time offsets may be performed once, upon initial receipt of image data from all the cameras. Alternatively, it may be performed periodically, such as for example each frame or some number of frames.

Step 608 further includes the operation of calibrating the positions of all cameras with respect to each other in the x, y, z Cartesian space of the scene. Once this information is known, the hub 12 and/or the one or more processing units 4 is able to form a scene map or model identify the geometry of the scene and the geometry and positions of objects (including users) within the scene. In calibrating the image data of all cameras to each other, depth and/or RGB data may be used. Technology for calibrating camera views using RGB information alone is described for example in U.S. Patent Publication No. 2007/0110338, entitled “Navigating Images Using Image Based Geometric Alignment and Object Based Controls,” published May 17, 2007, which publication is incorporated herein by reference in its entirety.

The imaging cameras in system 10 may each have some lens distortion which may be corrected for in order to calibrate the images from different cameras. Once all image data from the various cameras in the system is received in steps 604 and 630, the image data may be adjusted to account for lens distortion for the various cameras in step 674. The distortion of a given camera (depth or RGB) may be a known property provided by the camera manufacturer. If not, algorithms are known for calculating a camera's distortion, including for example imaging an object of known dimensions such as a checker board pattern at different locations within a camera's FOV. The deviations in the camera view coordinates of points in that image will be the result of camera lens distortion. Once the degree of lens distortion is known, distortion may be corrected by known inverse matrix transformations that result in a uniform camera view map of points in a point cloud for a given camera.

The hub 12 may next translate the distortion-corrected image data points captured by each camera from the camera view to an orthogonal 3-D world view in step 678. This orthogonal 3-D world view is a point cloud map of all image data captured by capture device 20 and the head mounted display device cameras in an orthogonal x, y, z Cartesian coordinate system. Methods using matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000), which publication is incorporated herein by reference in its entirety. See also, U.S. patent application Ser. No. 12/792,961, previously incorporated by reference.

Each camera in system 10 may construct an orthogonal 3-D world view in step 678. The x, y, z world coordinates of data points from a given camera are still from the perspective of that camera at the conclusion of step 678, and not yet correlated to the x, y, z world coordinates of data points from other cameras in the system 10. The next step is to translate the various orthogonal 3-D world views of the different cameras into a single overall 3-D world view shared by all cameras in system 10.

To accomplish this, embodiments of the hub 12 may next look for key-point discontinuities, or cues, in the point clouds of the world views of the respective cameras in step 682. Once found, the hub then identifies cues that are the same between different point clouds of different cameras in step 684. Once the hub 12 is able to determine that two world views of two different cameras include the same cues, the hub 12 is able to determine the position, orientation and focal length of the two cameras with respect to each other and the cues in step 688. In embodiments, not all cameras in system 10 will share the same common cues. However, as long as a first and second camera have at least one shared cue, and at least one of those cameras has at least one shared view with a third camera, the hub 12 is able to determine the positions, orientations and focal lengths of the first, second and third cameras relative to each other and a single, overall 3-D world view. The same is true for additional cameras in the system.

Various known algorithms exist for identifying cues from an image point cloud. Such algorithms are set forth for example in Mikolajczyk, K., and Schmid, C., “A Performance Evaluation of Local Descriptors,” IEEE Transactions on Pattern Analysis & Machine Intelligence, 27, 10, 1615-1630. (2005), which paper is incorporated by reference herein in its entirety. A further method of detecting cues with image data is the Scale-Invariant Feature Transform (SIFT) algorithm. The SIFT algorithm is described for example in U.S. Pat. No. 6,711,293, entitled, “Method and Apparatus for Identifying Scale Invariant Features in an Image and Use of Same for Locating an Object in an Image,” issued Mar. 23, 2004, which patent is incorporated by reference herein in its entirety. Another cue detector method is the Maximally Stable Extremal Regions (MSER) algorithm. The MSER algorithm is described for example in the paper by J. Matas, O. Chum, M. Urba, and T. Pajdla, “Robust Wide Baseline Stereo From Maximally Stable Extremal Regions,” Proc. of British Machine Vision Conference, pages 384-396 (2002), which paper is incorporated by reference herein in its entirety.

In step 684, cues which are shared between point clouds from two or more cameras are identified. Conceptually, where a first group of vectors exist between a first camera and a group of cues in the first camera's Cartesian coordinate system, and a second group of vectors exist between a second camera and that same group of cues in the second camera's Cartesian coordinate system, the two systems may be resolved with respect to each other into a single Cartesian coordinate system including both cameras. A number of known techniques exist for finding shared cues between point clouds from two or more cameras. Such techniques are shown for example in Arya, S., Mount, D. M., Netanyahu, N. S., Silverman, R., and Wu, A. Y., “An Optimal Algorithm For Approximate Nearest Neighbor Searching Fixed Dimensions,” Journal of the ACM 45, 6, 891-923 (1998), which paper is incorporated by reference herein in its entirety. Other techniques can be used instead of, or in addition to, the approximate nearest neighbor solution of Arya et al., incorporated above, including but not limited to hashing or context-sensitive hashing.

Where the point clouds from two different cameras share a large enough number of matched cues, a matrix correlating the two point clouds together may be estimated, for example by Random Sampling Consensus (RANSAC), or a variety of other estimation techniques. Matches that are outliers to the recovered fundamental matrix may then be removed. After finding a group of assumed, geometrically consistent matches between a pair of point clouds, the matches may be organized into a group of tracks for the respective point clouds, where a track is a group of mutually matching cues between point clouds. A first track in the group may contain a projection of each common cue in the first point cloud. A second track in the group may contain a projection of each common cue in the second point cloud. The point clouds from different cameras may be resolved into a single point cloud in a single orthogonal 3-D real-world view.

The positions and orientations of the cameras are calibrated with respect to this single point cloud and single orthogonal 3-D real-world view. In order to resolve the various point clouds together, the projections of the cues in the group of tracks for two point clouds are analyzed. From these projections, the hub 12 can determine the perspective of a first camera with respect to the cues, and can also determine the perspective of a second camera with respect to the cues. From that, the hub 12 can resolve the point clouds into an estimate of a single point cloud and single orthogonal 3-D real-world view containing the cues and other data points from both point clouds.

This process is repeated for any other cameras, until the single orthogonal 3-D real-world view includes all cameras. Once this is done, the hub 12 can determine the relative positions and orientations of the cameras relative to the single orthogonal 3-D real-world view and each other. The hub 12 can further determine the focal length of each camera with respect to the single orthogonal 3-D real-world view.

Referring again to FIG. 9, once the system is calibrated in step 608, a scene map may be developed in step 610 identifying the geometry of the scene as well as the geometry and positions of objects within the scene. In embodiments, the scene map generated in a given frame may include the x, y and z positions of all users, real-world objects and virtual objects in the scene. All of this information is obtained during the image data gathering steps 604, 630 and 656 and is calibrated together in step 608.

At least the capture device 20 includes a depth camera for determining the depth of the scene (to the extent it may be bounded by walls, etc.) as well as the depth position of objects within the scene. As explained below, the scene map is used in positioning virtual objects within the scene, as well as displaying virtual three-dimensional objects with the proper occlusion (a virtual three-dimensional object may be occluded, or a virtual three-dimensional object may occlude, a real-world object or another virtual three-dimensional object).

The system 10 may include multiple depth image cameras to obtain all of the depth images from a scene, or a single depth image camera, such as for example depth image camera 426 of capture device 20 may be sufficient to capture all depth images from a scene. An analogous method for determining a scene map within an unknown environment is known as simultaneous localization and mapping (SLAM). One example of SLAM is disclosed in U.S. Pat. No. 7,774,158, entitled “Systems and Methods for Landmark Generation for Visual Simultaneous Localization and Mapping,” issued Aug. 10, 2010, which patent is incorporated herein by reference in its entirety.

In step 612, the system will detect and track moving objects such as humans moving in the room, and update the scene map based on the positions of moving objects. This may include the use of skeletal models of the users within the scene as described above. In step 614, the hub determines the x, y and z position, the orientation and the FOV of each head mounted display device 2 for all users within the system 10. Further details of step 614 are now described with respect to the flowchart of FIG. 11. The steps of FIG. 11 are described below with respect to a single user. However, the steps of FIG. 11 would be carried out for each user within the scene.

In step 700, the calibrated image data for the scene is analyzed at the hub to determine both the user head position and a face unit vector looking straight out from a user's face. The head position may be identified in the skeletal model. The face unit vector may be determined by defining a plane of the user's face from the skeletal model, and taking a vector perpendicular to that plane. This plane may be identified by determining a position of a user's eyes, nose, mouth, ears or other facial features. The face unit vector may be used to define the user's head orientation and, in examples, may be considered the center of the FOV for the user. The face unit vector may also or alternatively be identified from the camera image data returned from the cameras 112 on head mounted display device 2. In particular, based on what the cameras 112 on head mounted display device 2 see, the associated processing unit 4 and/or hub 12 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from capture device 20, the cameras on the head mounted display device 2 for the subject user and/or from the head mounted display device(s) 2 of other users.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the hub may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined The range of view of a user of a head mounted display device 2 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's FOV is also useful for determining what a user cannot see. As explained below, limiting processing of virtual objects to those areas that are within a particular user's FOV may improve processing speed and reduces latency.

In the embodiment described above, the hub 12 calculates the FOV of the one or more users in the scene. In further embodiments, the processing unit 4 for a user may share in this task. For example, once user head position and eye orientation are estimated, this information may be sent to the processing unit which can update the position, orientation, etc. based on more recent data as to head position (from IMU 132) and eye position (from eye tracking assembly 134).

Returning now to FIG. 9, the one or more users may have created virtual objects in the scene. As a user moves around within a scene, and changes his position and/or FOV, the appearance of virtual objects will change. For example, if a user moves closer to a virtual object, the object may be projected larger. If a user moves around a virtual object, the virtual object is displayed from a different vantage point. This change in appearance due to change in user perspective is distinguished from a change in appearance of a virtual object due to editing the virtual object as explained below.

In step 618, the hub 12 may use the scene map of the user position and FOV to determine the appearance of all virtual objects at the current time. This information may be determined from steps 700, 704, 706 and 710 described above for FIG. 11, where the user's FOV is determined relative to the scene map. These changes in the displayed appearance of the virtual object are provided to the hub 12, and the hub can then update the orientation, appearance, etc. of the virtual three-dimensional object from the user's perspective in step 618. Alternatively, this information may be generated by one or more of the processing units 4 and sent to the hub 12 in step 618.

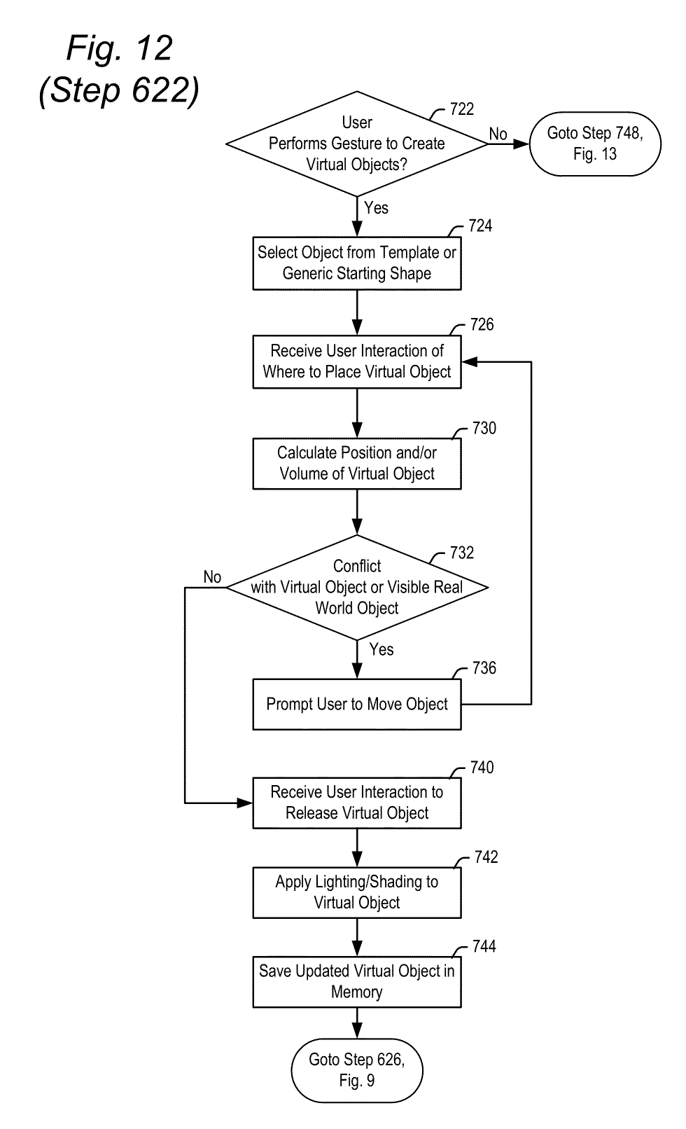

In step 622, the hub computing system looks for predefined user gestures indicating a desire to create, edit or animate virtual objects within the scene. Further details of step 622 are now described with reference to the flowcharts of FIGS. 12-14. Referring initially to step 722 in FIG. 12, the system may look for a predefined gesture or sequence of gestures indicating that the user wishes to create a virtual object. These gestures can be physical or verbal. If such a gesture is detected, the system allows a user to select an object to be created in step 724.

The content-generation software application running on the hub may include menus of predefined objects from which a user can select. A user can use the predefined objects as is, or the user can edit them as explained below. Templates of predefined objects may be provided by an author of the content-generation software application. Additionally or alternatively, as a user or others edit and create new virtual objects, these may be stored and added to the templates of predefined objects. As an alternative to predefined objects, a user may select a generic starting shape, which the user can thereafter shape and sculpt into the desired virtual image. For this option, the user may select from a menu of multiple generic starting shapes (cuboid, cylindrical, spherical, etc.).

The menu of objects can be presented to the user on a virtual display slate. A virtual display slate is a virtual screen displayed to the user via head mounted display 2 and including content such as menus or templates with virtual objects from which to select. The opacity filter 114 is used to mask real-world objects and light behind (from the user's view point) the virtual display slate, so that the virtual display slate appears as a virtual screen for viewing selected content.

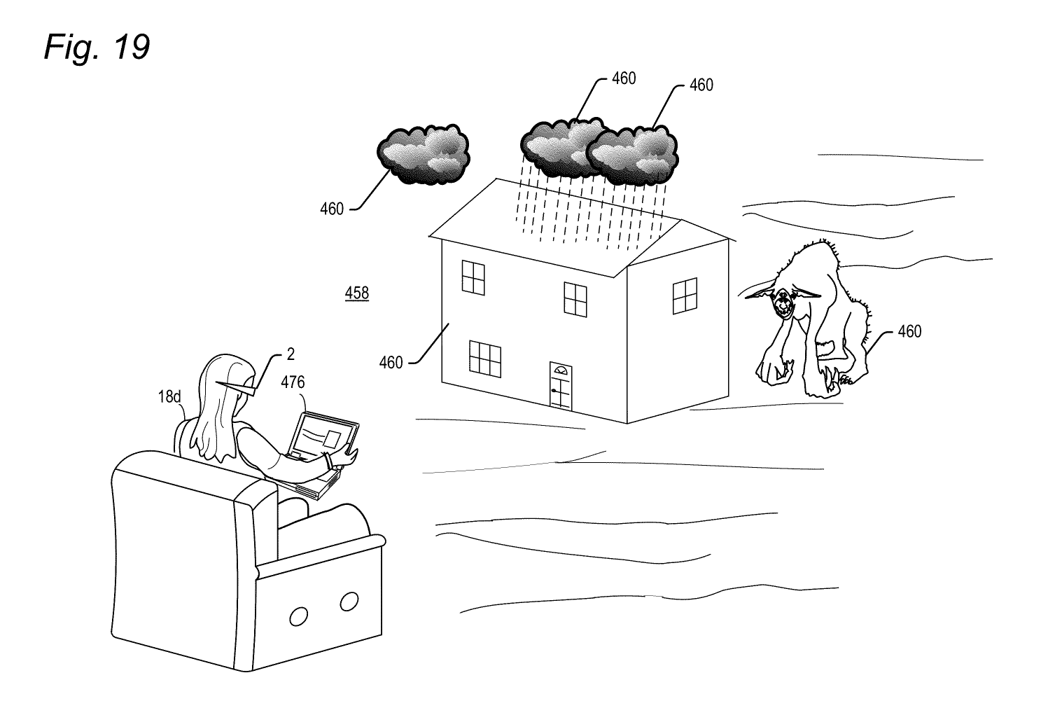

A user may scroll through object menus displayed to the user with various verbal and/or physical gestures. As a non-limiting example, a user may say “show me trees,” whereupon different trees may be displayed to the user on the virtual display slate. The user may then select a tree from the menu by pointing at it or by gazing at it for a predetermined period of time. In alternative embodiments, the virtual display slate may be omitted and a user may simply select objects using verbal commands. In further embodiments, described below with respect to FIG. 19, a user may also operate a keyboard, input device and monitor for presenting objects for selection.

Once an object is selected in step 724, the hub 12 may receive user input as to where to place the selected virtual object. A user may provide this indication using any of various predefined gestures, which may be physical or verbal. In one example shown in FIG. 8, the user 18a may touch his closed hand to the ground where the user wants to place the virtual object in the virtual environment. The user may thereafter raise his closed hand upward so that the virtual object 460a springs upward from the ground at the desired location and to the desired height. The user can move the virtual object 460a around as desired, and can release the virtual object by opening his hand, as explained below.

A user can walk around a virtual environment and create any number of virtual objects in this manner. As an alternative, a user may place selected objects in the virtual environment by performing a throwing motion. Upon recognizing such a predefined gesture, the system can interpret the user's arm speed and direction, and determine a position where the trajectory of an object (if actually thrown with the user's motion) would intersect the ground. The selected object may be created at that location. As a further possibility, a user may focus his gaze at a location for a predetermined period of time, and the selected object may be created at that location. It is understood that one or more virtual objects may be selected and placed at desired locations in the virtual environment using a variety of other gestures, physical and/or verbal, or a sequence of gestures.

In placing virtual objects, a user may not be bound by physics which would affect the object if it were real. For example, a user can generate a virtual house or building, and carry it around the virtual environment and then place it at a desired location.

In step 730, the system determines a position of the created virtual object in three-dimensional space. Alternatively or additionally, the system can determine a volume of the created virtual object. A volume indicates the positions in three-dimensional space of points on the outer surface of the virtual object. Step 730 may be performed as part of step 610 (FIG. 9) described above.

Where the virtual environment is meant to comprise real-world objects and virtual objects, it may be set up so that a created virtual object does not occupy the same space as a visible (non-occluded) real-world object or another virtual object. On the other hand, where an environment is completely virtual, any real-world objects may be occluded and a virtual object may occupy the same space as an occluded real-world object (though possibly not the same space as another virtual object).

Accordingly, in step 732, the hub 12 may check for a conflict between a virtual object or a visible real-world object. If such a conflict is detected, the system may prompt a user to move the newly created virtual object, and the system may return to step 726 to receive an indication of the new position. In an alternative embodiment, instead of prompting, the system may automatically move the newly created virtual object to a proximate non-conflicting position.

If no conflict is detected in step 732, the system may look for a physical gesture releasing the virtual object at the selected position in step 740. For example, in the embodiment of FIG. 8, once the user has pulled the virtual object up through the ground, the user may release it at the desired location. As noted above, there are embodiments where the user may create virtual objects without ever initially grasping them. In such alternative embodiments, the user may place a virtual object at a desired location without having to release it, and step 740 may be omitted.

Another feature of building virtual objects directly into a virtual environment is that lighting and shading may automatically be applied to a created virtual object. In particular, a user may have set the position, type and intensity of one or more light sources for a virtual environment. If so, whenever a virtual object is added to the scene, the lighting and/or shading may be applied to the virtual object in step 742 resulting from the selected light source(s).

In step 744, the position of the virtual object may be stored in memory. As noted above, a virtual object may be created and displayed over several frames. Thus, the virtual object may be stored each frame to capture the progress in creating the object. The virtual object may be stored once every preset number of frames in further embodiments. Saved virtual objects may be used only for the virtual environment scene being created by the user. However, as also noted above, created virtual objects may be added to templates that can be made available to that user and other users for use in creating other scenes in a virtual environment. It is further contemplated that virtual objects created via the virtual environment described above can be added to templates that are presented to users of conventional content-generation software applications using a keyboard, input device and monitor.

In the embodiments described above, virtual objects may be created from stored virtual objects. In further embodiments, virtual objects may alternatively or additionally be created from real-world objects. For example, if a user wanted to create a virtual object of a desk, chair, telephone or other objects, the user could generate those from a real-world desk, chair, telephone or other real object (respectively). As described above, the mixed reality system includes sensing systems, for example in the hub 12 and in the head mounted display 2. These sensing systems can pick up the detail of a real-world object, either by the hub 12 itself, or a user walking around a real-world object so that the head mounted display 2 picks up the detail of the object.

Thereafter, this data may be fed to the content-generation software application running on hub 12, which can then recreate a virtual object which is a replica of the real-world object. In addition to the object itself, the system may capture surface properties, such as texture and how light reflects off the real-world object, and recreate those surface properties in the replica.

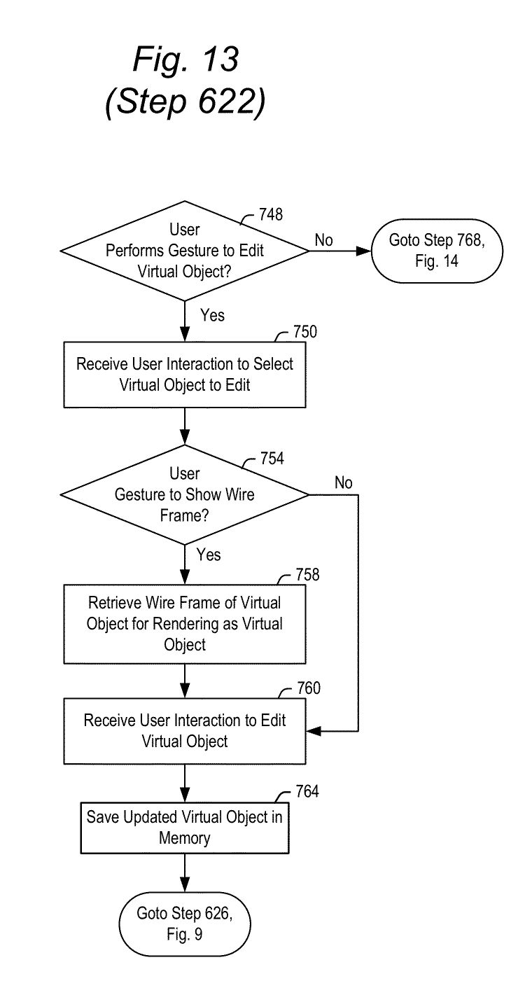

If, in step 722, the system did not detect a gesture meant to create an object, the system next looks in step 748 (FIG. 13) for a gesture indicating that the user wishes to edit a previously-created virtual object. These gestures can be physical or verbal. If such a gesture is detected, the system detects user interaction to select the object to be edited in step 750. This selection interaction can be a physical gesture, such as pointing or gazing at a particular virtual object, or it can be a verbal gesture.

It is known for virtual objects to be created using a wire frame including a number of interconnected points which generally define the shape of the virtual object. Thereafter, a surface can be fitted to the points, and one or more different textures laid over the surface to form the finished virtual object. In editing a virtual object, a user can work with the textured virtual object, or may revert to a display of the wire frame of the virtual object. In step 754, the system looks for a predefined gesture indicating the user would like to view and work with the wire frame of the virtual object. If received, the system retrieves the wire frame of the virtual object to be displayed upon the next render step 646 (FIG. 9) described below. If no such predefined gesture is received, the textured image of the virtual object is displayed to the user for editing in the render step 646.

In step 760, the system receives user interaction to edit a virtual object. This editing input may be accomplished using a wide variety of user gestures, physical and/or verbal. In one example, a user may physically manipulate virtual objects to change their shape or perform some other edit to the virtual object. As used herein, physical manipulation of a virtual object by a user refers to a correspondence between a virtual object's effective real-world location, and the real-world location of the user's physical actions. In a non-limiting example shown in FIG. 8, user 18b is editing virtual object 460b by grabbing portions of a virtual object and either stretching those portions or compressing (pinching) those portions. The user's hands in real-world space are positioned around the effective real-world locations of the portions grabbed. Depending on the gestures used, and the points comprising the wire frame, the stretching/compressing may affect the virtual object as a whole or only the localized portions of the virtual object grabbed by the user.

In the example of FIG. 8, the user 18b has grabbed a first branch with his left hand and stretched that branch. The user has grabbed a second branch with his right hand and similarly stretched that branch. The user could have performed predefined gestures to similarly make the tree larger, or change the aspect ratio by changing its height or width. The user could further perform predefined gestures to rotate the virtual object (about pitch, yaw and/or roll axes), or bend the virtual object about a selected point in the object to a desired degree (for example by placing one hand at the bending point, and pushing the object with the other hand to bend about the selected point).

Alternatively or additionally, a user could select a portion or all of a virtual object, and perform a gesture to change the texture of the object. Upon performing this gesture, different textures may be displayed to the user, for example on menus provided on a virtual display slate as described above. A user can select a texture as by pointing, gazing or with a verbal command, and apply it to portions of a virtual object, or the object as a whole, again by pointing, gazing or with a verbal command. Using a combination of physical and/or verbal gestures, a user may edit a virtual object in a wide variety of ways until satisfied with the completed virtual object.

As noted above, instead of a selecting a predefined virtual object, a user may start with a generic starting shape. In such embodiments, a user may edit the generic starting shape into a desired virtual object. An example of a generic starting shape 466 is shown in FIG. 16. In the example shown, the user has chosen to view the generic starting shape as a wire frame (step 754), and is in the process of adding points 468 to the wire frame. Points 468 may be added to the wire frame such as by pointing at distinct positions on the surface of the generic starting shape 466 or by snapping fingers while looking at distinct positions on the surface. Thereafter, the user can grab one or more of the points 468 and pull, push or move the points to shape the virtual object as desired.

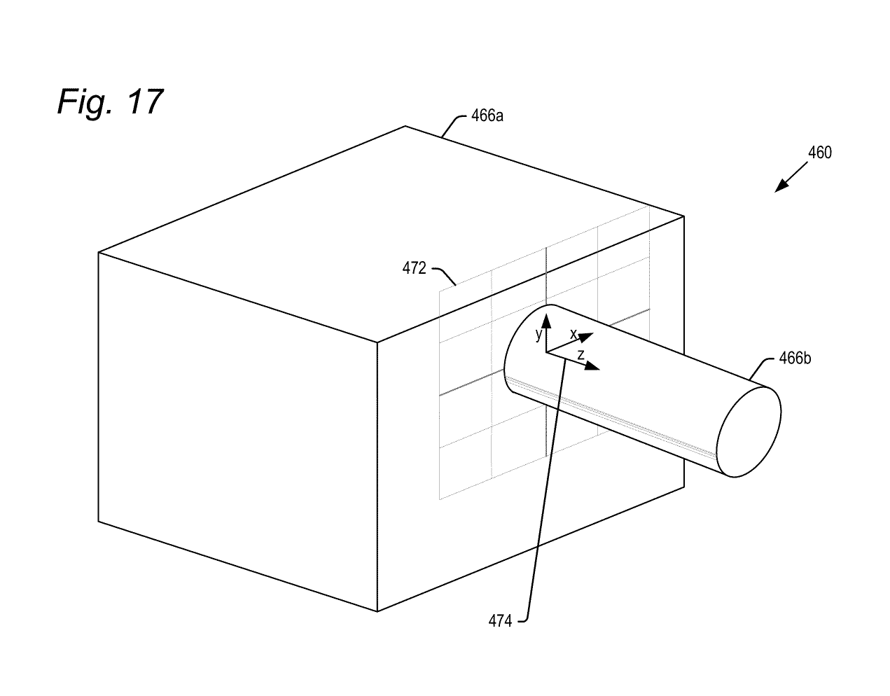

Instead of starting with a single generic starting shape, a user may build complex virtual objects using a plurality of generic starting shapes. One such example is shown in FIG. 17, where a generic starting shape 466b is being added to a generic starting shape 466a. When constructing a virtual object, the location of one shape (466b) can be based off of the position of another shape (466a). A wide variety of other shapes and connections may be used to construct virtual objects 460.

It is also known in conventional content-generation software applications to display drawing aids to a user associated with a given object. These drawing aids may similarly be displayed in association with a displayed virtual object 460. For example, FIG. 17 shows drawing aids in the form of a grid 472 and x, y, z axes 474. In embodiments, the user can for example select one of the displayed axes (as by grabbing it), and then stretch/compress the image (e.g., shape 466b) along the selected axis, or rotate the image about the selected axis.

In further embodiments, instead of or in addition to adding/manipulating wire frame points, the user may simply mold the generic starting shape 466 using natural hand motions or other gestures, as if sculpting a lump of clay to a desired shape. In this embodiment, the system is able to detect the user's hand movements relative to the space occupied by the virtual object, and interpret how the user wishes to alter the appearance of the virtual object. Physics may be used so that forceful hand movements result in a greater change in an impacted area of the virtual object than would a subtle hand movement.

Once the desired shape is attained from the generic starting shape, the user can add one or more textures to the virtual object. These textures may be displayed to the user, for example on menus provided on a virtual display slate as described above. A user can select a texture, for example by pointing or gazing, and apply it to portions of a virtual object, or the object as a whole, again by pointing or gazing.

Instead of, or in addition to, physically grabbing and manipulating a virtual object, a user may accomplish edits using eye gaze and/or verbal commands. Thus, as one of myriad examples, instead of being proximate an object, a user may move to a corner remote from the virtual objects to gain perspective of the virtual scene. A user could then select one or more virtual objects to be edited, for example by pointing or gazing at each object to be selected. Thereafter, the user could edit the selected object(s), for example changing the texture of each object with a verbal command, such as “paint each tree yellow.” The user may change other attributes of a distal virtual image in a similar manner, for example by selecting one or more virtual objects and speaking a desired, predefined command, such as “scale brightness by 50%,” or “change height for half of the selected trees.” A wide variety of other physical and/or verbal commands are possible.

Once satisfied with the edits to a virtual object, the object may be saved in memory in step 764. As above, the edited object may also be made available on a template for use again by the user or others.

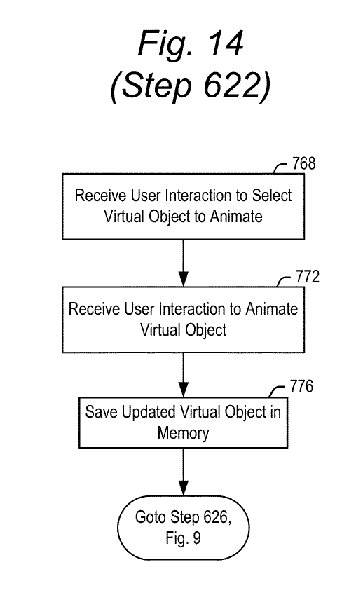

If, in step 748, the system did not detect a gesture meant to edit an object, the system next looks for an animation gesture in step 768 (FIG. 14). An animation gesture may be physical or verbal. When such a gesture is detected, the system also detects user interaction to select a particular object to be animated in step 768. Again, this selection interaction can be a physical gesture, such as pointing or gazing at a particular virtual object, and/or it can be a verbal gesture.

Once an object to be animated is selected, the system looks for a user interaction to animate the virtual object in step 772. This animation interaction may be accomplished using a wide variety of predefined user gestures, physical and/or verbal. In the example of FIG. 8, after an object has been created, a user may for example repeatedly push on a portion of a tree in a periodic motion. The period and magnitude of the push may be sensed by the system, and replicated in an animation making that portion of the tree sway back and forth, for example as if swaying in the wind. Animation may be imparted by a user spinning, moving, bouncing, or performing some other gesture on a virtual object.

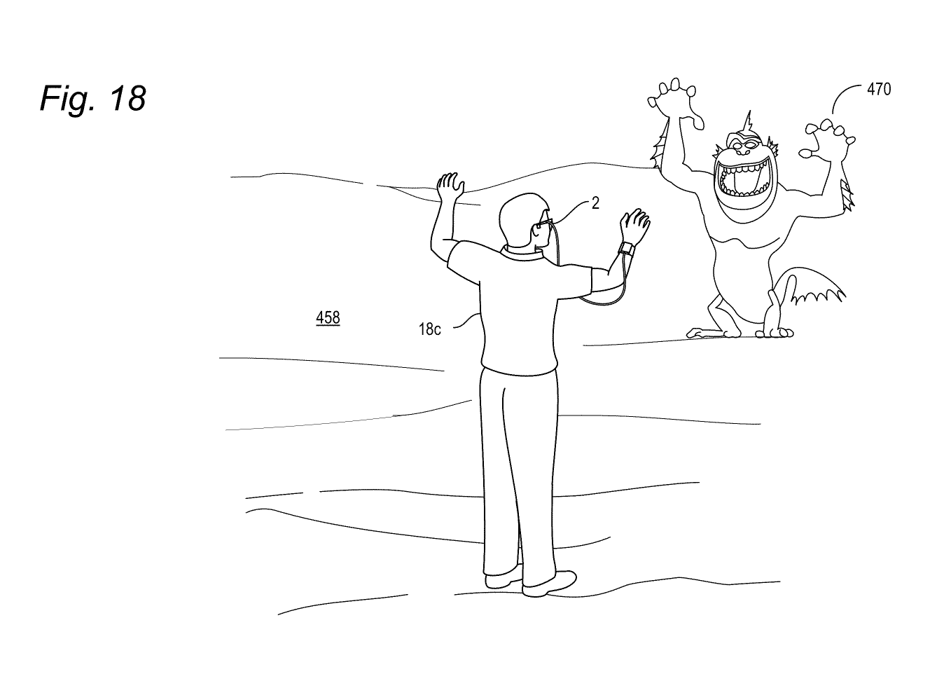

In a further embodiment, where a virtual object is an image of an animate object (person, animal, monster) or an inanimate object such as a robot, the virtual object may be animated by replicating detected movements of the user. For example, FIG. 18 shows an example of a user 18c performing gestures to animate a monster 470. The user has raised his hands above his head, and may have opened his mouth as if letting out a roar. These body positions are detected by the hub 12 and replicated in the monster 470. The user may perform various movements with his arms, legs, torso, head and/or eyes, all of which can be detected by the system and imparted to a virtual object as animation. In further embodiments, a user may speak, with the sounds or spoken words replicated and imparted to a selected virtual object as part of its animation.

Once satisfied with the animation added to a virtual object, the object may be saved in memory in step 776. As above, the animated object may also be made available on a template for use again by the user or others.

A virtual scene may be constructed by a single user. However, another feature of the present technology is that a virtual scene may be constructed collaboratively. For example, FIG. 8 shows two users, each viewing the virtual environment through their head mounted display 2 from their own perspective. Each user can be working on different portions of the scene to create, edit and/or animate virtual objects. Alternatively, the users may be working together in creating, editing and/or animating a single virtual object within the scene. As one user makes a change, that change may be visible to the other user(s), from their perspective and FOV of the scene. In further embodiments users can be remote from each other (in different rooms, cities, states, countries), but viewing a common virtual scene they are working on collaboratively via a network connection. Again, even though remote, when one user makes a change to a virtual object, that change may be visible to the other user(s) who are viewing the scene.

The system as described above provides ease-of-use benefits by using a natural user interface to create, edit and animate virtual objects. Separate and apart from this, the present system further provides benefits by allowing a user to see how a virtual object will look and fit in a virtual environment as the virtual object is created. Conventional content-generation applications using a monitor require a user to guess how various aspects of a virtual object will translate when the virtual object is displayed in the virtual environment. The present technology removes this guesswork by immersing the user in the virtual scene together with the object being created.

For example, instead of having to change the view perspective on a monitor as with conventional content-generation packages, the present technology allows a user to view an object in a more natural way, as if it were a real object in the real world. A user may move closer to/further from the virtual object, or move around the virtual object, for example in a full circle and see it from all angles to provide a more natural viewing interaction with the virtual object. A user is able to walk around a virtual environment and notice things about a virtual object that may not be apparent with the more artificial method of displaying different views of an object over a monitor. Furthermore, the authoring user is also able to see a virtual object stereoscopically (left and right views), as will an end user viewing the virtual object.

In addition to a more natural view of the object itself, creating the object in the virtual environment also makes it easier to provide the virtual object in the proper perspective with respect to other objects in the virtual environment or the virtual environment as a whole. For example, when creating a virtual object with conventional content-generation software, each perspective provided on the monitor may have its own FOV and perspective parameters. These parameters may not translate from the monitor to display of the virtual object in the virtual environment. As such, an object which appears correctly sized on the monitor may be too big or too small when placed in the virtual environment with other virtual objects.

It may be that an important visual aspect in a video game appeared reasonably well on a monitor, but becomes too difficult to see when displayed in the actual virtual environment, thus adversely affecting game mechanics. By building virtual objects directly into a virtual environment in which an authoring user is immersed, the authoring user is provided with an improved sense of scale and perspective. An authoring user can see virtual objects in relation to other virtual/real objects, and the authoring user can view virtual objects just as will an end user.

Embodiments of the present technology provide ease of use through a natural user interface. User commands are more intuitive, and a user is not required to remember keyboard/input device commands associated with use of a conventional content-generation software application. However, in an alternative embodiment shown in FIG. 19, a conventional content-generation software application may be incorporated into the present system. FIG. 19 shows a user 18d immersed in a virtual environment 458 (the view shown in FIG. 19 would be seen for example through a head mounted display device 2). The user is creating virtual objects 460, which are displayed to the user in the virtual environment through her head mounted display device 2.

The user is able to interact with the virtual objects 460 shown as described above. However, in addition, the user may interact with the virtual object via a device 476 which may for example be a computer having a keyboard and input device such as a mouse. Using known commands input by the keyboard and input device, the user may interact with a content-generation software application running on the hub 12 to create, edit and/or animate the virtual objects 460. Thus, FIG. 19 presents a hybrid embodiment, where a user generates virtual objects via a keyboard and input device, but is able to view the virtual objects 460 being generated from within the virtual environment 458 in which the virtual object is displayed.

The device 476 may be a real-world device, such as a laptop or other computer. Alternatively, the device 476 may be a virtual device, and for example display a monitor to the user on a virtual display slate.

Returning now to FIG. 9, after creation, editing or animation of a virtual object is performed in step 622, the hub 12 may transmit the determined information to the one or more processing units 4 in step 626. The information transmitted in step 626 includes transmission of the scene map to the processing units 4 of all users. The transmitted information may further include transmission of the determined FOV of each head mounted display device 2 to the processing units 4 of the respective head mounted display devices 2. The transmitted information may further include transmission of virtual object characteristics, including the determined position, orientation, shape and appearance.

The processing steps 600 through 626 are described above by way of example only. It is understood that one or more of these steps may be omitted in further embodiments, the steps may be performed in differing order, or additional steps may be added. The processing steps 604 through 618 may be computationally expensive but the powerful hub 12 may perform these steps several times in a 60 Hertz frame. In further embodiments, one or more of the steps 604 through 618 may alternatively or additionally be performed by one or more of the one or more processing units 4. Moreover, while FIG. 9 shows determination of various parameters, and then transmission of these parameters all at once in step 626, it is understood that determined parameters may be sent to the processing unit(s) 4 asynchronously as soon as they are determined.

The operation of the processing unit 4 and head mounted display device 2 will now be explained with reference to steps 630 through 656. The following description is of a single processing unit 4 and head mounted display device 2. However, the following description may apply to each processing unit 4 and display device 2 in the system.

As noted above, in an initial step 656, the head mounted display device 2 generates image and IMU data, which is sent to the hub 12 via the processing unit 4 in step 630. While the hub 12 is processing the image data, the processing unit 4 is also processing the image data, as well as performing steps in preparation for rendering an image.

In step 634, the processing unit 4 may cull the rendering operations so that only those virtual objects which could possibly appear within the final FOV of the head mounted display device 2 are rendered. The positions of other virtual objects may still be tracked, but they are not rendered. It is also conceivable that, in further embodiments, step 634 may be skipped altogether and the entire image is rendered.

The processing unit 4 may next perform a rendering setup step 638 where setup rendering operations are performed using the scene map and FOV received in step 626. Once virtual object data is received, the processing unit may perform rendering setup operations in step 638 for the virtual objects which are to be rendered in the FOV. The setup rendering operations in step 638 may include common rendering tasks associated with the virtual object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

Referring again to FIG. 9, using the information received from the hub 12 in step 626, the processing unit 4 may next determine occlusions and shading in the user's FOV in step 644. In particular, the screen map has x, y and z positions of objects in the scene, including moving and non-moving objects and the virtual objects. Knowing the location of a user and their line of sight to objects in the FOV, the processing unit 4 may then determine whether a virtual object partially or fully occludes the user's view of a visible real-world object. Additionally, the processing unit 4 may determine whether a visible real-world object partially or fully occludes the user's view of a virtual object. Occlusions may be user-specific. A virtual object may block or be blocked in the view of a first user, but not a second user. Accordingly, occlusion determinations may be performed in the processing unit 4 of each user. However, it is understood that occlusion determinations may additionally or alternatively be performed by the hub 12.

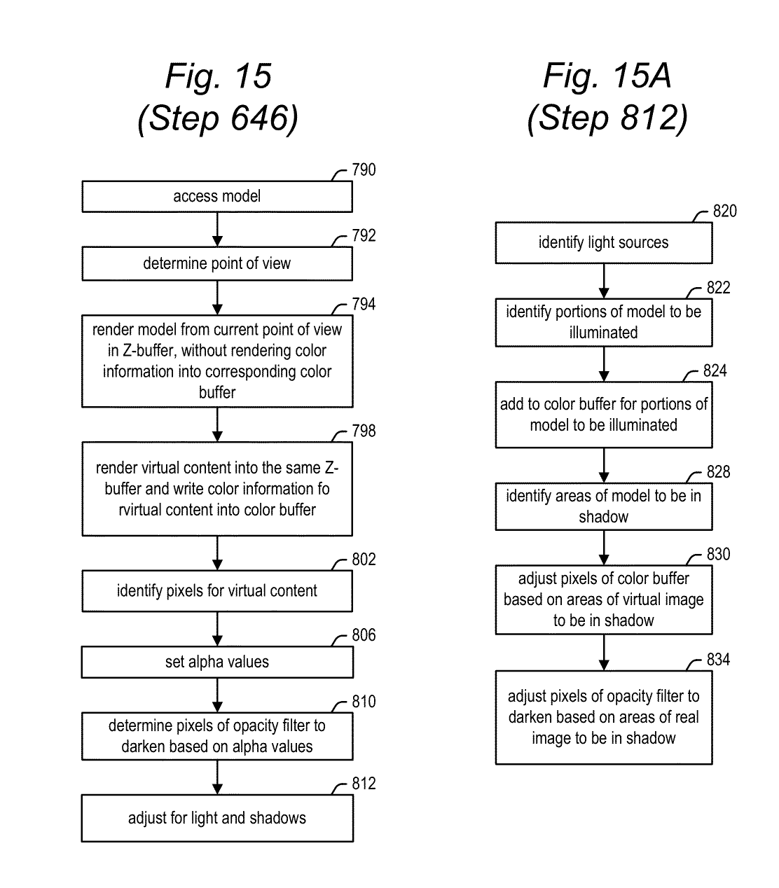

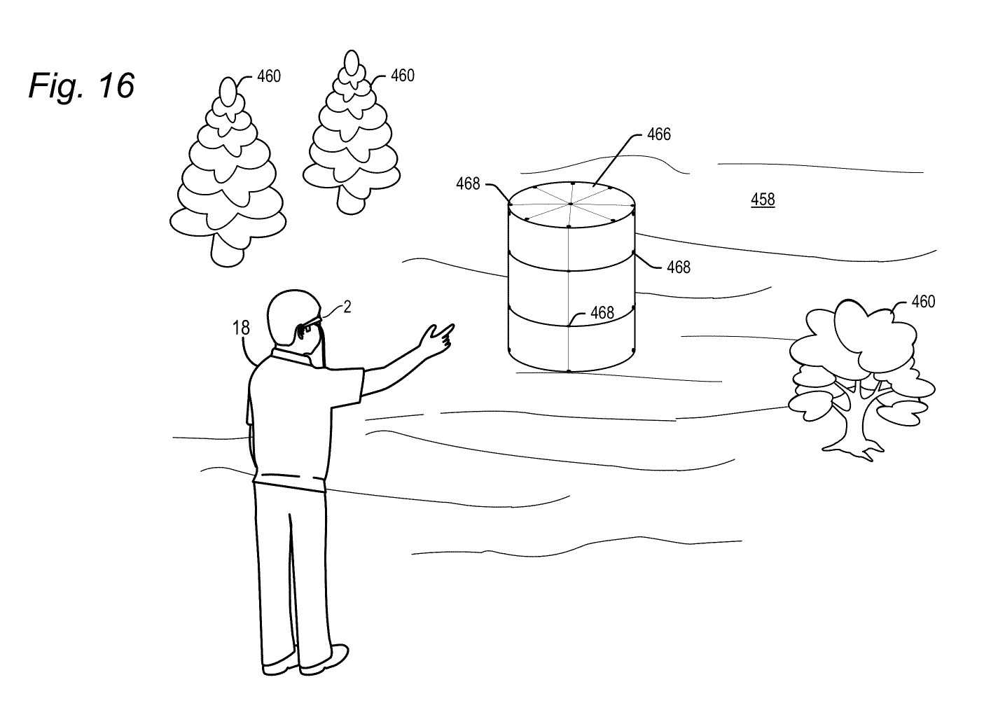

In step 646, the GPU 322 of processing unit 4 may next render an image to be displayed to the user. Portions of the rendering operations may have already been performed in the rendering setup step 638 and periodically updated. Further details of the rendering step 646 are now described with reference to the flowchart of FIGS. 15 and 15A.

In step 790 of FIG. 15, the processing unit 4 accesses the model of the environment. In step 792, the processing unit 4 determines the point of view of the user with respect to the model of the environment. That is, the system determines what portion of the environment or space the user is looking at. In one embodiment, step 792 is a collaborative effort using hub computing device 12, processing unit 4 and head mounted display device 2 as described above.

In step 794, the system renders the previously created three-dimensional model of the environment from the point of view of the user of head mounted display device 2 in a z-buffer, without rendering any color information into the corresponding color buffer. This effectively leaves the rendered image of the environment to be all black, but does store the z (depth) data for the objects in the environment. Step 794 results in a depth value being stored for each pixel (or for a subset of pixels).

In step 798, virtual content (including virtual objects being constructed, edited, animated or which have been completed) is rendered into the same z-buffer, and the color information for the virtual content is written into the corresponding color buffer. This effectively allows the virtual objects to be drawn on the headset microdisplay 120 taking into account occlusions of a virtual object by visible real-world objects or other virtual objects.

In step 802, the system identifies the pixels of microdisplay 120 that display virtual objects. In step 806, alpha values are determined for the pixels of microdisplay 120. In traditional chroma key systems, the alpha value is used to identify how opaque an image is, on a pixel-by-pixel basis. In some applications, the alpha value can be binary (e.g., on or off). In other applications, the alpha value can be a number with a range. In one example, each pixel identified in step 802 will have a first alpha value and all other pixels will have a second alpha value.

In step 810, the pixels for the opacity filter 114 are determined based on the alpha values. In one example, the opacity filter 114 has the same resolution as microdisplay 120 and, therefore, the opacity filter can be controlled using the alpha values. In another embodiment, the opacity filter has a different resolution than microdisplay 120 and, therefore, the data used to darken or not darken the opacity filter will be derived from the alpha value by using any of various mathematical algorithms for converting between resolutions. Other means for deriving the control data for the opacity filter based on the alpha values (or other data) can also be used.

In step 812, the images in the z-buffer and color buffer, as well as the alpha values and the control data for the opacity filter, are adjusted to account for light sources (virtual or real) and shadows (virtual or real). More details of step 812 are provided below with respect to FIG. 15A. The process of FIG. 15 allows for automatically displaying a virtual object over a stationary or moving object (or in relation to a stationary or moving object).

FIG. 15A is a flowchart describing one embodiment of a process for accounting for light sources and shadows, which is an example implementation of step 812 of FIG. 15. In step 820, processing unit 4 identifies one or more light sources that may be accounted for. For example, a real light source may be accounted for when drawing a virtual image. If the system is adding a virtual light source to the user's view, then the effect of that virtual light source can be accounted for in the head mounted display device 2 as well. In step 822, the portions of the model (including virtual objects) that are illuminated by the light source are identified. In step 824, an image depicting the illumination is added to the color buffer described above.

In step 828, processing unit 4 identifies one or more areas of shadow that may be added by the head mounted display device 2. For example, if a virtual object is added to an area in a shadow, then the shadow may be accounted for when drawing the virtual object by adjusting the color buffer in step 830. If a virtual shadow is to be added where there is no virtual object, then the pixels of opacity filter 114 that correspond to the location of the virtual shadow are darkened in step 834.

In conjunction with a rendered image, the hub computing system may also provide audio over the speakers 25 (FIG. 1). The audio may be associated with a scene in general. Alternatively or additionally, the audio may be associated with a specific virtual object. Where associated with a specific virtual object, the audio may have a directional component. Thus, where two users are viewing a virtual object having associated audio, the object being to the left of a first user and to the right of the second user, the corresponding audio will appear to come from the left of the first user and to the right of the second user. This effect may be generated by spatially separated speakers 25. While FIG. 1 shows two speakers 25, there may be more than two speakers in further embodiments.

Returning to FIG. 9, in step 650, the processing unit checks whether it is time to send a rendered image to the head mounted display device 2, or whether there is still time for further refinement of the image using more recent position feedback data from the hub 12 and/or head mounted display device 2. In a system using a 60 Hertz frame refresh rate, a single frame is about 16 ms.

In particular, the composite image based on the z-buffer and color buffer (described above with respect to FIGS. 15 and 15A) is sent to microdisplay 120. That is, the images for the one or more virtual objects are sent to microdisplay 120 to be displayed at the appropriate pixels, accounting for perspective and occlusions. At this time, the control data for the opacity filter is also transmitted from processing unit 4 to head mounted display device 2 to control opacity filter 114. The head mounted display would then display the image to the user in step 658.

On the other hand, where it is not yet time to send a frame of image data to be displayed in step 650, the processing unit may loop back for more updated data to further refine the predictions of the final FOV and the final positions of objects in the FOV. In particular, if there is still time in step 650, the processing unit 4 may return to step 608 to get more recent sensor data from the hub 12, and may return to step 656 to get more recent sensor data from the head mounted display device 2.

The processing steps 630 through 652 are described above by way of example only. It is understood that one or more of these steps may be omitted in further embodiments, the steps may be performed in differing order, or additional steps may be added.

Moreover, the flowchart of the processor unit steps in FIG. 9 shows all data from the hub 12 and head mounted display device 2 being cyclically provided to the processing unit 4 at the single step 634. However, it is understood that the processing unit 4 may receive data updates from the different sensors of the hub 12 and head mounted display device 2 asynchronously at different times. The head mounted display device 2 provides image data from cameras 112 and inertial data from IMU 132. Sampling of data from these sensors may occur at different rates and may be sent to the processing unit 4 at different times. Similarly, processed data from the hub 12 may be sent to the processing unit 4 at a time and with a periodicity that is different than data from both the cameras 112 and IMU 132. In general, the processing unit 4 may asynchronously receive updated data multiple times from the hub 12 and head mounted display device 2 during a frame. As the processing unit cycles through its steps, it may use the most recent data it has received when extrapolating the final predictions of FOV and object positions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a virtual environment to one or more users, the virtual environment being coextensive with a real-world space, the system comprising:
a display device for a user, the display device including a display unit for displaying one or more virtual objects in the virtual environment to the user of the display device; and
a computing system operatively coupled to the display device, the computing system generating the one or more virtual objects in the virtual environment based on input from the user, the one or more virtual objects displayed via the display device as the one or more virtual objects are generated in the virtual environment.

2. The system of claim 1, wherein the computing system generates a virtual object by creating the virtual object in the virtual environment in response to gestures from the user indicating the type of virtual object to be created in the virtual environment.

3. The system of claim 1, wherein the computing system generates a virtual object by creating the virtual object in the virtual environment in response to gestures from the user indicating at least one of a position of the virtual object in the virtual environment and a size of the object in the virtual environment.

4. The system of claim 3, wherein the computing system receives gestures indicating at least one of the position and size of the object within the virtual environment by the user performing at least one of the following gestures: i) pulling up the virtual object from a floor of the virtual environment at the position and to the size desired by the user; ii) a throwing motion, a trajectory of an object thrown with the throwing motion used to determine the position of the virtual object in the virtual environment; and iii) the user looking at a location in the virtual environment for a predetermined period of time to position the virtual object at the location.

5. The system of claim 3, wherein the computing system receives a gesture to create a virtual object by replicating a real-world object.

6. The system of claim 1, wherein the computing system edits a virtual object in the virtual environment in response to one or more gestures from the user.

7. The system of claim 6, wherein the computing system edits the virtual object in response to one or more gestures from the user by changing at least one of a height, width, color and texture of the virtual object.

8. The system of claim 6, wherein the computing system edits the virtual object in response to one or more gestures from the user by adding and moving points to a wire frame representation of the virtual object.

9. The system of claim 6, wherein the computing system edits the virtual object in response to the user performing hand gestures molding the virtual object to a desired shape.

10. The system of claim 1, wherein the computing system animates a virtual object in the virtual environment in response to one or more gestures from the user.

11. A method for generating virtual objects in a virtual environment, the virtual environment coextensive with a real-world space, the method comprising:
(a) altering a virtual object in the virtual environment in response to interaction with the virtual object within the virtual environment; and
(b) saving the alteration to the virtual object made in said step (a).

12. The method of claim 11, wherein said step (a) of altering the virtual object comprises at least one of altering a position, size, shape, color and texture of the virtual object.

13. The method of claim 11, wherein said step (a) of altering the virtual object in response to user interaction comprises altering the virtual object in response to at least one of one or more physical gestures performed by the user and one or more verbal gestures spoken by the user.

14. The method of claim 13, wherein said step (a) comprises altering the virtual object in response to one or more physical gestures performed by the user, the physical gestures are performed at a position in three-dimensional space occupied by the virtual object to alter a shape of the virtual object.

15. The method of claim 11, further comprising the step of displaying the virtual object in the virtual environment to the user via a display device.

16. A method of generating one or more virtual objects in a virtual environment, the virtual environment coextensive with a real-world space, the method comprising:
(a) receiving a selection of a virtual object to add to the virtual environment;
(b) receiving an indication of a position within the virtual environment where the virtual object is to be added;
(c) adding the virtual object selected in said step (a) to the virtual environment at the position indicated in said step (b);
(d) displaying the virtual object via a display device from different perspectives as a position of the display device changes within the virtual environment; and
(e) altering a shape of the virtual object in response physical gestures performed at one or more positions in three-dimensional space occupied by the virtual object.

17. The method of claim 16, wherein said step (e) comprises the step of making at least a portion of the virtual object larger as a result of performing a gesture to pull on the virtual object in the virtual environment.

18. The method of claim 16, wherein said step (e) comprises the step of making at least a portion of the virtual object smaller as a result of performing a gesture to push on the virtual object in the virtual environment.

19. The method of claim 16, wherein said step (e) comprises the step of changing at least one of a position, size, texture and color of the virtual object in the virtual environment in response to the user performing one or more gestures physically manipulating the virtual object in the virtual environment.

20. The method of claim 16, further comprising the step (f) of changing at least one of a position, size, texture and color of the virtual object in the virtual environment in response to the user performing a verbal gesture while positioned distally from the virtual object in the virtual environment.
